(19) United States
(12) Patent Application Publication
(10) Pub. No.: US 2011/0249907 A1
(43) Pub. Date: Oct. 13, 2011

(54) IMAGE COMPARISON APPARATUS, IMAGE COMPARISON METHOD, AND PROGRAM

(76) Inventors: Takahiro FUKUHARA, Kanagawa (JP); Hitoshi KIYA, Tokyo (JP)

(21) Appl. No.: 13/077,498

(22) Filed: Mar. 31, 2011

(30) Foreign Application Priority Data
Apr. 8, 2010 (JP) 2010-089326

(51) Int. Cl. G06K 9/36

(52) U.S. Cl. 382/235

(57) ABSTRACT

A code block size comparison unit examines an inclusion relationship of code block size. A comparing target code block determination unit determines a comparing target code block based on an inclusion relationship of code block. A zero bit plane number comparison unit compares the numbers of zero bit planes of the comparing target code blocks and determines match or mismatch between a specific image and a comparing target code stream. The invention can be applied to, for example, an image comparison apparatus.

### BACKGROUND OF THE INVENTION

1. Field of the Invention

The present invention relates to an image comparison apparatus, an image comparison method, and a program, and more particularly, to an image comparison apparatus, an image comparison method, and a program capable of realizing image comparison with high precision even when encoding parameters used in encoding are different.

2. Description of the Related Art

In the related art, for the purpose of searching for a video content, a technique is necessary which searches for an image substantially identical to a specific image from unknown video contents with a query of searching for the specific image. For example, a technique has been suggested which searches for an image substantially identical to a specific image from video contents by extracting feature amounts for respective short-time frames from the video contents, constructing feature vectors, and comparing the feature vectors with those of the specific image (for example, see Japanese Patent Application Laid-Open No. 2004-45565).

In recent years, apparatuses, such as digital cameras or digital camcorders, directly photographing digital images and performing image compression to record the images have come into wide use. Moreover, in recent years, television programs have been digitized, image-compressed, and stored in archives. Furthermore, after regulating the JPEG 2000 scheme as an image compression standard of the digital cinema standard in 2004, many films have been digitized and subjected to compression encoding according to the JPEG 2000 scheme.

Accordingly, in the future, it is particularly expected that there is an increasing demand to search for an image substantially identical to a specific image from a plurality of images subjected to compression encoding according to the JPEG 2000 scheme. Moreover, it is expected that there is an increasing demand to search for an image substantially identical to a specific image from video contents subjected to compression encoding according to the JPEG 2000 scheme. The technique disclosed in Japanese Patent Application Laid-Open No. 2004-45565, however, has an issue that the calculation amount of processing overall increases since it is necessary to completely decode images or video contents before searching.

In order to solve this issue, there has been suggested an image comparison apparatus and an image comparison method capable of determining identity or similarity with a specific image without completely decoding the images subjected to the compression encoding according to the JPEG 2000 scheme or the like (for example, see Japanese Patent Application Laid-Open No. 2006-285615). Japanese Patent Application Laid-Open No. 2006-285615 discloses an image searching apparatus, an image searching method, a program, and a recording medium capable of searching for an image substantially identical to the specific image without completely decoding the video contents subjected to the compression encoding according to the JPEG 2000 scheme or the like.

According to the technique disclosed in Japanese Patent Application Laid-Open No. 2006-285615, there are provided: first feature amount extraction means for extracting the number of zero bit planes of each code block from a code stream of JPEG 2000; encoding parameter extraction means for extracting an encoding parameter from the code stream; second feature amount extraction means for performing wavelet transform and quantization on a specific image based on the encoding parameter, splitting a quantization coefficient into code blocks, and extracting the number of zero bit planes of each code block; and comparison means for comparing the number of zero bit planes of each code block of the code stream with the number of zero bit planes of each code block of the specific image for each code block located at the same position and determining whether the code stream is substantially identical to the specific image based on the comparison result.

The technique disclosed in Japanese Patent Application Laid-Open No. 2006-285615 has the advantage that the code stream and the specific image can be compared with each other without complete decoding of the video content subjected to the compression encoding according to the JPEG 2000 scheme or the like.

### SUMMARY OF THE INVENTION

However, it is necessary to extract an encoding parameter from the code stream and perform the compression encoding on the specific image based on the encoding parameter. Therefore, when the code stream and the specific image are different in the encoding parameter such as the number of resolution levels or the size of the code blocks, the numbers of zero bit planes may not be compared with each other due to the mismatch in the numbers of zero bit planes.

In light of the foregoing, it is desirable to provide a novel and improved technique for comparing images, which are different in an encoding parameter such as the number of resolution levels or the size of code blocks, with each other with high precision.

According to an embodiment of the present invention, there is provided an image comparison apparatus which compares a specific image with a first code stream obtained by encoding an image according to a JPEG 2000 scheme and determines whether the image before the encoding of the first code stream is identical to the specific image, the image comparison apparatus which includes encoding parameter specifying means for analyzing the first code stream and specifying an encoding parameter used when the first code stream is generated, first zero bit plane number detection means for detecting the number of zero bit planes of each code block of the first code stream, encoding parameter setting means for encoding the specific image according to the JPEG 2000 scheme and setting an encoding parameter to be used when a second code stream is generated, second zero bit plane number detection means for detecting the number of zero bit planes of each code block of the second code stream obtained by encoding the specific image according to the JPEG 2000 scheme, encoding parameter comparison means for comparing the encoding parameter specified by the encoding parameter specifying means with the encoding parameter set by the encoding parameter setting means, and determination means for comparing the number of zero bit planes detected by the first zero bit plane number detection means with the number of zero bit planes detected by the second zero bit plane number detection means between the code blocks corresponding to each other in the first and second code streams according to a relationship between the encoding parameters compared and specified by the encoding parameter comparison means, determining that the image before the encoding of the first code stream is identical to the specific image when the numbers of zero bit planes are equal to each other, and determining that the image before the encoding of the first code stream is not identical to the specific image when the numbers of zero bit planes are not equal to each other.

The encoding parameter may include a code block size. The encoding parameter specifying means may specify a code block size of the first code stream. The encoding parameter setting means may set a code block size of the second code stream. The encoding parameter comparison means may compare the code block size of the first code stream with the code block size of the second code stream to specify an inclusion relationship between the code block of the first code stream and the code block of the second code stream. The determination means may compare the numbers of zero bit planes with each other between the code blocks corresponding to each other in the first and second code streams according to the inclusion relationship.

The encoding parameter may include the number of division levels of wavelet transform. The encoding parameter specifying means may specify the number of division levels of the first code stream. The encoding parameter setting means may set the number of division levels of the second code stream. The encoding parameter comparison means may compare the number of division levels of the first code stream with the number of division levels of the second code stream to specify a sub-band which is common to the first and second code streams. The determination means may compare the numbers of zero bit planes with each other between the code blocks corresponding to each other in the sub-band which is common to the first and second code streams.

The determination means may determine that the image before the encoding of the first code stream is not identical to the specific image, when the number of code blocks determined not to be equal in the number of zero bit planes is equal to or greater than a predetermined threshold value.

The determination means may determine that the image before the encoding of the first code stream is not identical to the specific image, when there is a code block in which a difference in the number of zero bit planes is equal to or greater than a predetermined threshold value.

According to an embodiment of the present invention, there is provided an image comparison method of an image comparison apparatus which compares a specific image with a first code stream obtained by encoding an image according to a JPEG 2000 scheme and determines whether the image before the encoding of the first code stream is identical to the specific image, the image comparison method which includes the steps of analyzing the first code stream and specifying an encoding parameter used when the first code stream is generated, by encoding parameter specifying means of the image comparison apparatus, detecting the number of zero bit planes of each code block of the first code stream, by first zero bit plane number detection means of the image comparison apparatus, encoding the specific image according to the JPEG 2000 scheme and setting an encoding parameter to be used when a second code stream is generated, by encoding parameter setting means of the image comparison apparatus, detecting the number of zero bit planes of each code block of the second code stream obtained by encoding the specific image according to the JPEG 2000 scheme, by second zero bit plane number detection means of the image comparison apparatus, comparing the specified encoding parameter with the set encoding parameter, by encoding parameter comparison means of the image comparison apparatus, and comparing the numbers of zero bit planes detected in the code blocks corresponding to each other in the first and second code streams according to a relationship between the compared and specified encoding parameters, determining that the image before the encoding of the first code stream is identical to the specific image when the numbers of zero bit planes are equal to each other, and determining that the image before the encoding of the first code stream is not identical to the specific image when the numbers of zero bit planes are not equal to each other, by determination means of the image comparison apparatus.

According to an embodiment of the present invention, there is provided a program causing a computer, which compares a specific image with a first code stream obtained by encoding an image according to a JPEG 2000 scheme and determines whether the image before the encoding of the first code stream is identical to the specific image, to function as encoding parameter specifying means for analyzing the first code stream and specifying an encoding parameter used when the first code stream is generated, first zero bit plane number detection means for detecting the number of zero bit planes of each code block of the first code stream, encoding parameter setting means for encoding the specific image according to the JPEG 2000 scheme and setting an encoding parameter to be used when a second code stream is generated, second zero bit plane number detection means for detecting the number of zero bit planes of each code block of the second code stream obtained by encoding the specific image according to the JPEG 2000 scheme, encoding parameter comparison means for comparing the encoding parameter specified by the encoding parameter specifying means with the encoding parameter set by the encoding parameter setting means, and determination means for comparing the number of zero bit planes detected by the first zero bit plane number detection means with the number of zero bit planes detected by the second zero bit plane number detection means between the code blocks corresponding to each other in the first and second code streams according to a relationship between the encoding parameters compared and specified by the encoding parameter comparison means, determining that the image before the encoding of the first code stream is identical to the specific image when the numbers of zero bit planes are equal to each other, and determining that the image before the encoding of the first code stream is not identical to the specific image when the numbers of zero bit planes are not equal to each other.

According to another embodiment of the present invention, there is provided an image comparison apparatus which compares first and second code streams with each other, which are obtained by encoding images according to a JPEG 2000 scheme, and determines whether the images before the encoding of the first and second code streams are identical to each other, the image comparison apparatus which includes first encoding parameter specifying means for analyzing the first code stream and specifying an encoding parameter used when the first code stream is generated, first zero bit plane number detection means for detecting the number of zero bit planes of each code block of the first code stream, second encoding parameter specifying means for analyzing the second code stream and specifying an encoding parameter used when the second code stream is generated, second zero bit plane number detection means for detecting the number of zero bit planes of each code block of the second code stream, encoding parameter comparison means for comparing the encoding parameter specified by the first encoding parameter specifying means with the encoding parameter specified by the second encoding parameter specifying means, and determination means for comparing the number of zero bit planes detected by the first zero bit plane number detection means with the number of zero bit planes detected by the second zero bit plane number detection means between the code blocks corresponding to each other in the first and second code streams according to a relationship between the encoding parameters compared and specified by the encoding parameter comparison means, determining the images before the encoding of the first and second code streams are identical to each other when the numbers of zero bit planes are equal to each other, and determining that the images before the encoding of the first and second code streams are not identical to each other when the numbers of zero bit planes are not equal to each other.

The encoding parameter may include a code block size. The first encoding parameter specifying means may specify a code block size of the first code stream. The second encoding parameter specifying means may specify a code block size of the second code stream. The encoding parameter comparison means may compare the code block size of the first code stream with the code block size of the second code stream to specify an inclusion relationship between the code block of the first code stream and the code block of the second code stream. The determination means may compare the numbers of zero bit planes with each other between the code blocks corresponding to each other in the first and second code streams according to the inclusion relationship.

The encoding parameter may include the number of division levels of wavelet transform. The first encoding parameter specifying means may specify the number of division levels of the first code stream. The second encoding parameter specifying means may specify the number of division levels of the second code stream. The encoding parameter comparison means may compare the number of division levels of the first code stream with the number of division levels of the second code stream to specify a sub-band which is common to the first and second code streams. The determination means may compare the numbers of zero bit planes to each other between the code blocks corresponding to each other in the sub-band which is common to the first and second code streams.

The determination means may determine that the images before the encoding of the first and second code streams are not identical to each other, when the number of code blocks determined not to be equal in the number of zero bit planes is equal to or greater than a predetermined threshold value.

The determination means may determine that the images before the encoding of the first and second code streams are not identical to each other, when there is a code block in which a difference in the number of zero bit planes is equal to or greater than a predetermined threshold value.

According to another embodiment of the present invention, there is provided an image comparison method of an image comparison apparatus which compares first and second code streams with each other, which are obtained by encoding images according to a JPEG 2000 scheme, and determines whether the images before the encoding of the first and second code streams are identical to each other, the image comparison method which includes the steps of analyzing the first code stream and specifying an encoding parameter used when the first code stream is generated, by first encoding parameter specifying means of the image comparison apparatus, detecting the number of zero bit planes of each code block of the first code stream, by first zero bit plane number detection means of the image comparison apparatus, analyzing the second code stream and specifying an encoding parameter used when the second code stream is generated, by second encoding parameter specifying means of the image comparison apparatus, detecting the number of zero bit planes of each code block of the second code stream, by second zero bit plane number detection means of the image comparison apparatus, comparing the encoding parameter specified by the first encoding parameter specifying means with the encoding parameter specified by the second encoding parameter specifying means, by encoding parameter comparison means of the image comparison apparatus, and comparing the numbers of zero bit planes between the code blocks corresponding to each other in the first and second code streams according to a relationship between the compared and specified encoding parameters, determining that the images before the encoding of the first and second code streams are identical to each other when the numbers of zero bit planes are equal to each other, and determining that the images before the encoding of the first and second code streams are not identical to each other when the numbers of zero bit planes are not equal to each other, by determination means of the image comparison apparatus.

According to another embodiment of the present invention, there is provided a program causing a computer, which compares first and second code streams with each other, which are obtained by encoding images according to a JPEG 2000 scheme, and determines whether the images before the encoding of the first and second code streams are identical to each other, to function as first encoding parameter specifying means for analyzing the first code stream and specifying an encoding parameter used when the first code stream is generated, first zero bit plane number detection means for detecting the number of zero bit planes of each code block of the first code stream, second encoding parameter specifying means for analyzing the second code stream and specifying an encoding parameter used when the second code stream is generated, second zero bit plane number detection means for detecting the number of zero bit planes of each code block of the second code stream, encoding parameter comparison means for comparing the encoding parameter specified by the first encoding parameter specifying means with the encoding parameter specified by the second encoding parameter specifying means, and determination means for comparing the number of zero bit planes detected by the first zero bit plane number detection means with the number of zero bit planes detected by the second zero bit plane number detection means between the code blocks corresponding to each other in the first and second code streams according to a relationship between the encoding parameters compared and specified by the encoding parameter comparison means, determining that the images before the encoding of the first and second code streams are identical to each other when the numbers of zero bit planes are equal to each other, and determining that the images before the encoding of the first and second code streams are not identical to each other when the numbers of zero bit planes are not equal to each other.

According to an embodiment of the present invention, a first code stream is analyzed and an encoding parameter used when the first code stream is generated is specified; the number of zero bit planes of each code block of the first code stream is detected; the specific image is encoded according to the JPEG 2000 scheme and an encoding parameter used when a second code stream is generated is set; the number of zero bit planes of each code block of the second code stream obtained by encoding the specific image according to the JPEG 2000 scheme is detected; the specified encoding parameter is compared with the set encoding parameter; and the number of detected zero bit planes is compared with the number of detected zero bit planes between the code blocks corresponding to each other in the first and second code streams according to a relationship between the compared and specified encoding parameters, it is determined that the image before the encoding of the first code stream is identical to the specific image when the numbers of zero bit planes are equal to each other, and it is determined that the image before the encoding of the first code stream is not identical to the specific image when the numbers of zero bit planes are not equal to each other.

According to another embodiment of the present invention, a first code stream is analyzed and an encoding parameter used when the first code stream is generated is specified; the number of zero bit planes of each code block of the first code stream is detected; a second code stream is analyzed and an encoding parameter used when the second code stream is generated is specified; the number of zero bit planes of each code block of the second code stream is detected; the specified encoding parameter for the first code stream is compared with the specified encoding parameter for the second code stream; and the number of detected zero bit planes of a code block of the first code stream is compared with the number of detected zero bit planes of a code block of the second code stream, the code blocks corresponding to each other in the first and second code streams, according to a relationship between the compared and specified encoding parameters, it is determined that the images before the encoding of the first and second code streams are identical to each other when the numbers of zero bit planes are equal to each other, and it is determined that the images before the encoding of the first and second code stream are not identical to each other when the numbers of zero bit planes are not equal to each other.

According to the embodiments of the present invention, it may be possible to realize comparison between images with high precision even when the images are different in an encoding parameter such as the number of resolution levels or the size of a code block.

### BRIEF DESCRIPTION OF THE DRAWINGS

FIG. 1 is a diagram illustrating that a specific image is searched for from a JPEG 2000 code stream database;

FIG. 2 is a diagram illustrating an example of sub-bands after wavelet transform processing in the JPEG 2000 scheme;

FIG. 3 is a diagram illustrating comparison of code blocks located at the same position;

FIG. 4 is a block diagram illustrating the schematic configuration of an image comparison apparatus disclosed in Japanese Patent Application Laid-Open No. 2006-285615;

FIG. 5 is a diagram illustrating a relationship between a code block and a bit plane;

FIG. 6 is a block diagram illustrating an exemplary main configuration of an image comparison apparatus according to embodiments of the invention;

FIG. 7 is a diagram illustrating an exemplary inclusion relationship of the code blocks;

FIG. 8 is a diagram illustrating an exemplary inclusion relationship of the code blocks;

FIG. 9 is a diagram illustrating an example of comparison between zero bit planes when the sizes of the code blocks are different from each other;

FIG. 10 is a flowchart illustrating an exemplary flow of a comparison process;

FIG. 11 is a flowchart illustrating the exemplary flow of the comparison process continued from FIG. 10;

FIG. 12 is a flowchart illustrating the exemplary flow of the comparison process continued from FIG. 11;

FIG. 13 is a block diagram illustrating another exemplary configuration of the image comparison apparatus according to the embodiments of the invention;

FIG. 14 is a flowchart illustrating another exemplary flow of the comparison process;

FIG. 15 is a flowchart illustrating another exemplary flow of the comparison process continued from FIG. 14;

FIG. 16 is a flowchart illustrating another exemplary flow of the comparison process continued from FIG. 15;

FIG. 17 is a block diagram illustrating still another exemplary configuration of the image comparison apparatus according to the embodiments of the invention;

FIG. 18 is a diagram illustrating classification when the numbers of resolution levels are different;

FIG. 19 is a flowchart illustrating an example of still another exemplary flow of the comparison process;

FIG. 20 is a flowchart illustrating still another exemplary flow of the comparison process continued from FIG. 19;

FIG. 21 is a flowchart illustrating still another exemplary flow of the comparison process continued from FIG. 20; and

FIG. 22 is a block diagram illustrating an exemplary main configuration of a personal computer according to an embodiment of the invention.

### DETAILED DESCRIPTION OF THE EMBODIMENTS

Hereinafter, preferred embodiments (hereinafter, referred to as embodiments) of the invention will be described in the following order.
1. First Embodiment (Image Comparison Apparatus: Comparison between Specific

Image and Code Stream when Sizes of Code Blocks Are Different)
2. Second Embodiment (Image Comparison Apparatus: Comparison between Code Streams when Sizes of Code Blocks Are Different)
3. Third Embodiment (Image Comparison Apparatus: Comparison between Code Streams when the Numbers of Resolution Levels Are Different)
4. Fourth Embodiment (Personal Computer)

### First Embodiment

### [Overview of Image Searching]

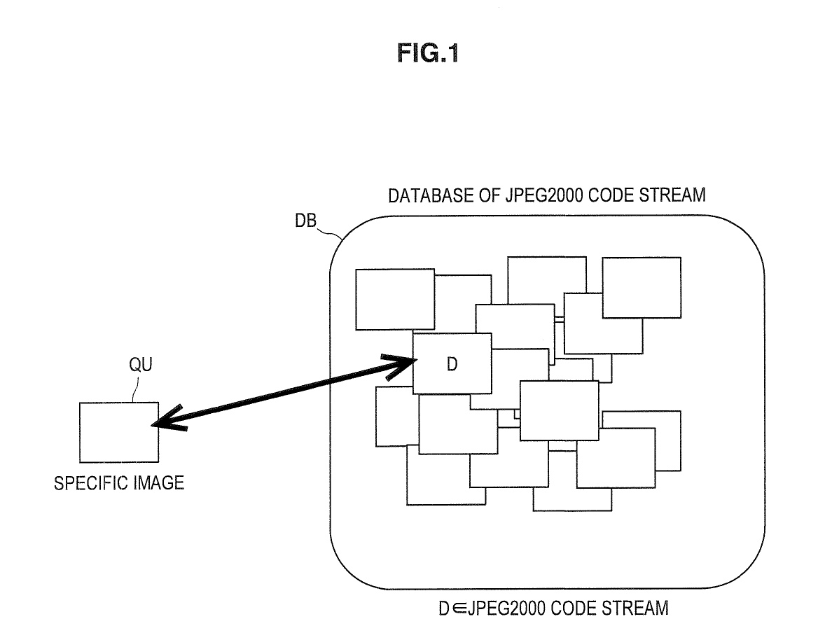

The invention relates to an image searching system, and more particularly, to an apparatus comparing a specific image with an image of a joint photographic experts group 2000 (JPEG 2000) code stream and classifying the images, as shown in FIG. 1, in an image searching system searching for an image D which is the same as a specific image QU from the JPEG 2000 code stream stored in database DB.

First, the overview of image comparison will be described.

A JPEG 2000 code stream is a code stream (encoded data) obtained by encoding image data according to the JPEG 2000 scheme. The encoding is performed using wavelet transform according to the JPEG 2000 scheme.

In the wavelet transform, an analysis filtering process is performed to split the image data into low-pass and high-pass components in vertical and horizontal directions of an image. That is, in the analysis filtering process, the image data is split into four components (sub-bands): a component (HH) which is high in the horizontal and vertical directions; a component (HL) which is high in the horizontal direction and is low in the vertical direction; a component (LH) which is low in the horizontal direction and is high in the vertical direction; and a component (LL) which is low in the horizontal and vertical directions.

The wavelet coefficient (coefficient data) included in each component (sub-band) is also image data of its band. In the wavelet transform, the analysis filtering process is iterated recursively a predetermined number of times for the component (LL), which is obtained through the analysis filtering process, low in the horizontal and vertical directions. That is, by performing the analysis filtering process N times, the coefficient data split into sub-bands of N hierarchies can be obtained.

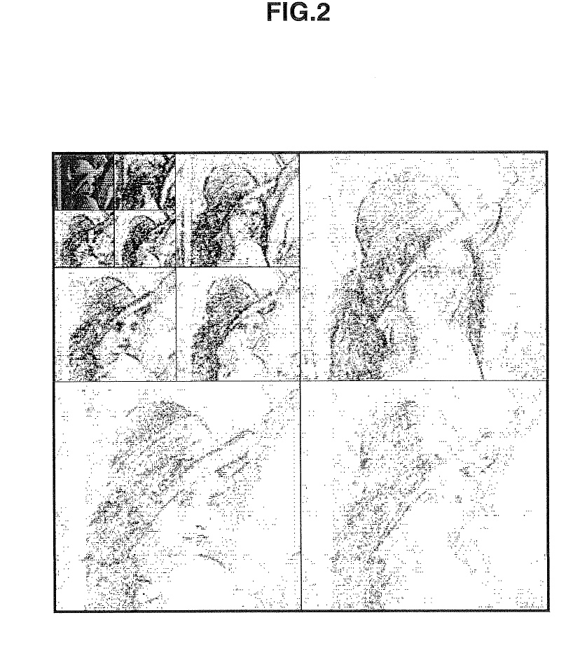

FIG. 2 is a diagram illustrating an exemplary result of the wavelet transform when the analysis filtering process is performed three times. In this case, as shown in FIG. 2, ten sub-bands of 3 hierarchies are generated. The number of hierarchies of the sub-bands is called a division level number. That is, in FIG. 2, the division level number is 3. As described above, the analysis filtering process is performed recursively on the component (LL) low in the horizontal and vertical directions. Therefore, a component (1LL) of a first hierarchy which is low in the horizontal and vertical directions and a component (2LL) of a second hierarchy which is low in the horizontal and vertical directions are further split.

As described above, the coefficient data of each sub-band is the image data. Therefore, as shown in FIG. 2, most of its energy focuses on the low-pass component. That is, in the image data of a baseband, the wavelet transform enables much energy to be focused on the further low-pass component (on a narrower range). In the encoding of the JPEG 2000 scheme, an encoding efficiency can be improved by performing such wavelet transform.

Typically, the wavelet transform is realized using a filter bank including a low-pass filter and a high-pass filter. Since the low-pass filter and the high-pass filter are typically realized by impulse responses (filter coefficients) of a plurality of tap lengths, it is necessary to provide a buffer that in advance buffers the input image to perform only filtering.

In the encoding of the JPEG 2000 scheme, the coefficient data of each sub-band is split further into code blocks which are smaller regions. Moreover, the coefficient data of each code block is developed into the bit plane of each position of the bit.

The bit plane is obtained by splitting (slicing) the coefficient data of each code block bit by bit, that is, position by position in the bit depth direction. That is, the bit plane is a set of bits (coefficient bits) having the same position in the coefficient data within the code block.

That is, on the assumption that a bit depth of each coefficient data has M bits, the coefficient data of each code block is developed into bit planes with M absolute values and a bit plane with one sign. Here, the components (one bit in the coefficient data) of the bit planes with the absolute values all have “0” or “1.” Moreover, the component of the bit plane indicating the sign has one of values indicating a positive value, 0, and a negative value as a coefficient.

In general, however, the value of a high-order bit easily becomes “0” for the coefficient data with a predetermined bit depth. A bit plane in which the values of all components are “0” continued from the MSB is called a zero bit plane.

When two images are identical to each other, the values of the respective coefficient data are equal to each other. That is, the numbers of zero bit planes are equal to each other between the code blocks located at the same position.

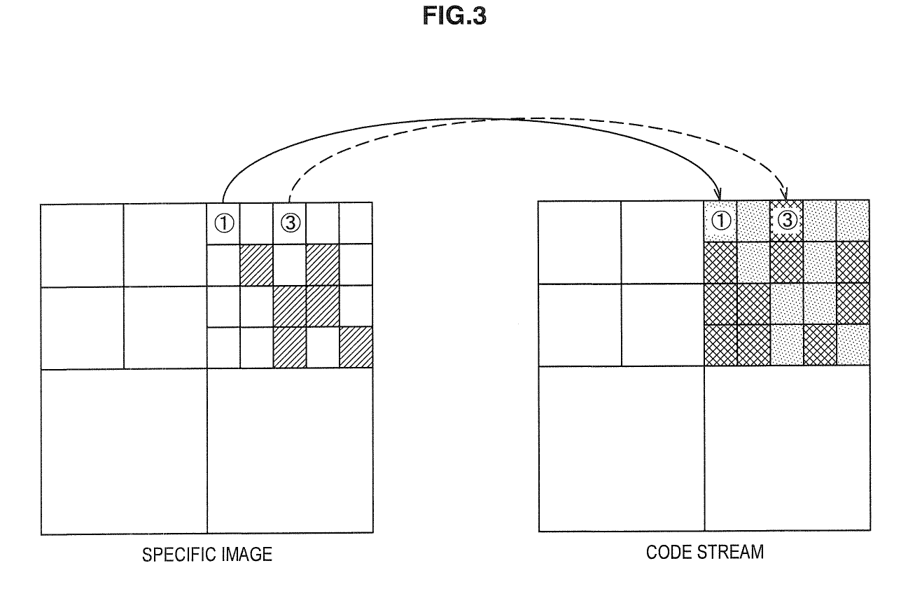

As shown in FIG. 3, the image comparison apparatus according to the embodiments of the invention performs identity determination by comparing the numbers of zero bit planes with each other between the code blocks located at the same position in a specific image and a JPEG 2000 code stream.

### [Configuration of Image Comparison Apparatus According to Related Art]

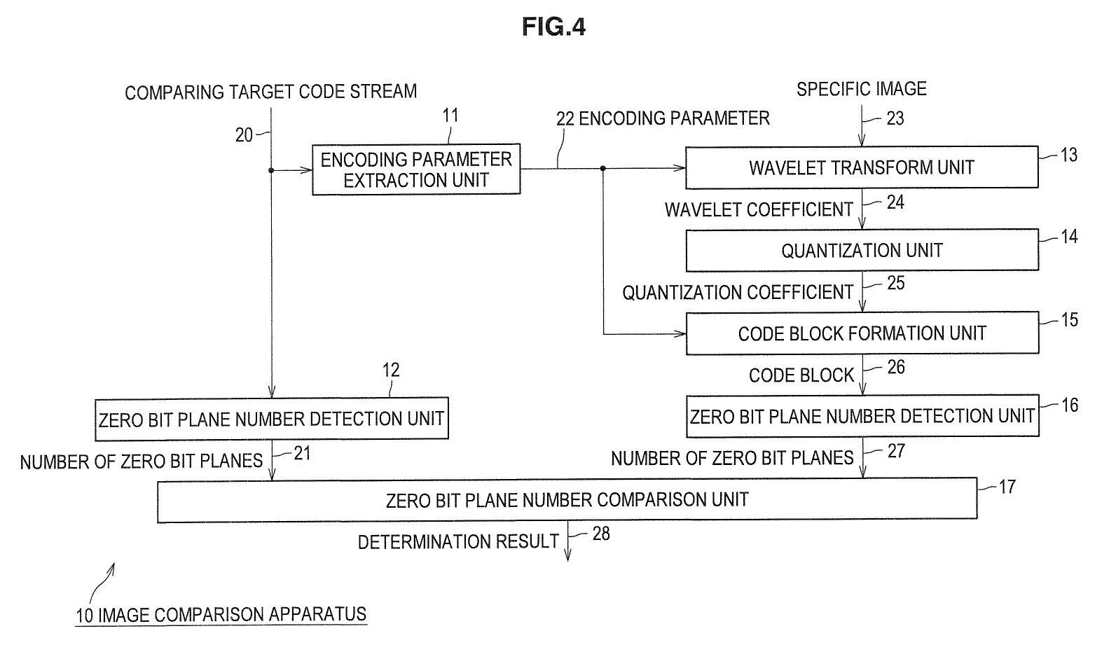

Next, an image comparison apparatus according to the related art will be described. FIG. 4 is a block diagram illustrating the schematic configuration of the image comparison apparatus disclosed in Japanese Patent Application Laid-Open No. 2006-285615.

As shown in FIG. 4, an encoding parameter extraction unit 11 of an image comparison apparatus 10 according to the related art extracts an encoding parameter from an input comparison target code stream (indicated by an arrow 20). A wavelet transform unit 13 performs wavelet transform on an input specific image (indicated by an arrow 23) using the encoding parameter (indicated by an arrow 22).

The quantization unit 14 quantizes a wavelet coefficient (indicated by an arrow 24) using the encoding parameter (indicated by the arrow 22). A code block formation unit 15 splits the quantization coefficient (indicated by an arrow 25) into code blocks (form code blocks) using the encoding parameter (indicated by the arrow 22).

A zero bit plane number detection unit 12 calculates the number of zero bit planes of the code block to be compared, from the input comparing target code stream (indicated by the arrow 20). A zero bit plane number detection unit 16 calculates the number of zero bit planes of the code block to be compared, from coefficient data (indicated by an arrow 26) of each code block.

A zero bit plane number comparison unit 17 compares the number of zero bit planes (indicated by an arrow 21) of the code block of the comparing target code stream with the number of zero bit planes (indicated by an arrow 27) of the code block of the specific image. Then, the zero bit plane number comparison unit 17 determines whether the comparing target code stream matches the specific image based on the comparison result.

According to the JPEG 2000 scheme, a quantization step size Ab is calculated by Expression (1) below. In Expression (1), Rb denotes a dynamic range of an image signal, b denotes a sub-band, sb denotes an exponent value, and μb denotes a mantissa. Similarly, an allowable maximum bit plane number Mb can be calculated by Expression (2).

Δb=2Rb−εb(1+μb/211) (1)

Mb=G+εb−1 (2)

Accordingly, when the value of the quantization step size is changed, sb which is one of factors thereof is also changed and the value of Mb is thus changed.

Therefore, the number of all bit planes is changed depending on a difference in the quantization parameter when encoding is performed according to the JPEG 2000 scheme.

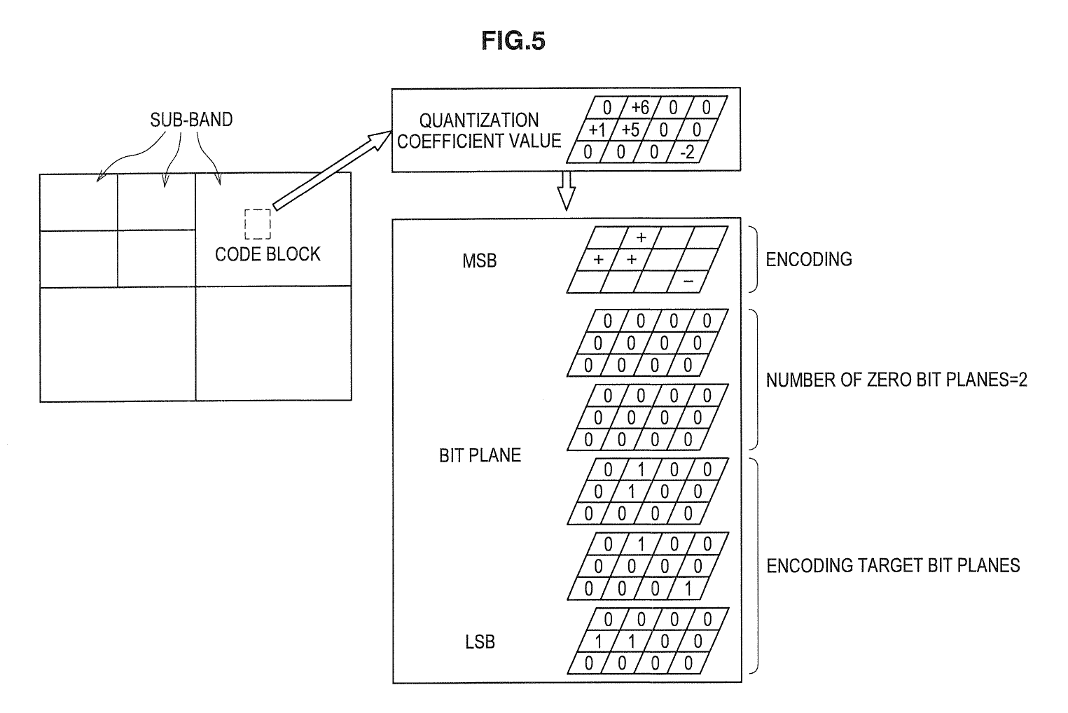

FIG. 5 is a diagram illustrating the relationship among a sub-band generated through wavelet transform, a code block, and a bit plane. The size of the code block is generally 64 by 64 or 32 by 32. In FIG. 5, a 4-by-3 code block is illustrated to facilitate easy understanding. The quantization coefficient value can be split into a sign (±) and absolute value information. The absolute value information is developed into a bit plane generated by binary digit representation.

As described above, among bit planes containing the most significant bit (MSB) to the least significant bit (LSB), a bit plane in which the values of all components consecutive from the MSB are “0” is called a zero bit plane. Accordingly, in FIG. 5, the number of zero bit planes is “2.”

In a method according to the related art, since the code blocks at the same position are compared with each other one by one, a comparing target code stream and a specific image have to be the same in size of the code block to be compared.

In some cases, however, the size of the code block of the specific image is preferably different from the size of the code block of the comparing target code stream. For example, when the encoding is performed on the specific image according to the JPEG 2000 scheme after the comparison of the images, it can be considered that the size of the code block of the comparing target code stream is not optimum for the specific image depending on the usage. In this case, in order to compare the images, the specific image has to be split so as to have the size of the code block of the comparing target code stream and has to be further split so as to have the desired size of the code block for encoding, thereby making the processing complicated.

### [Configuration of Image Comparison Apparatus]

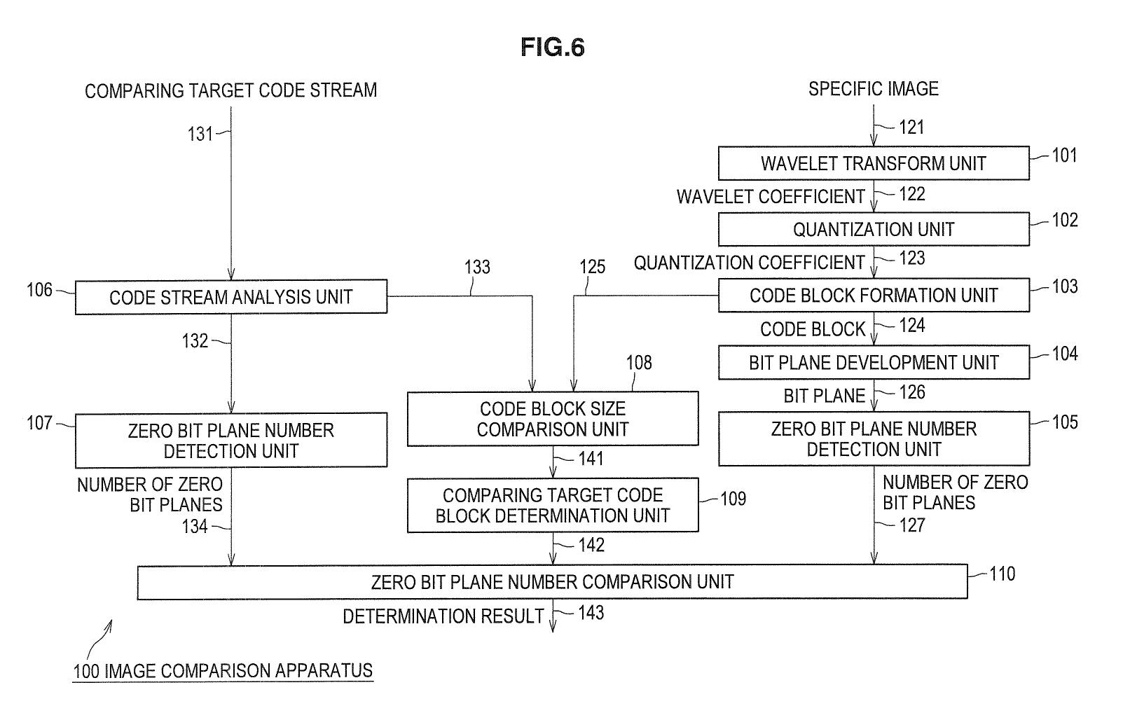

FIG. 6 is a block diagram illustrating an exemplary main configuration of the image comparison apparatus according to an embodiment of the invention.

As in the image comparison apparatus 10, an image comparison apparatus 100 shown in FIG. 6 compares the number of zero bit planes of each code block of the code stream obtained by encoding a specific image according to the JPEG 2000 scheme with the number of zero bit planes of each code block of a comparing target code stream, and determines whether an image before the encoding of the comparing target code stream is identical to the specific image depending on whether the numbers are identical to each other.

However, the image comparison apparatus 100 calculates the number of zero bit planes of the specific image without using the encoding parameter of the comparing target code stream. That is, the encoding parameter used when the specific image is encoded according to the JPEG 2000 scheme is independent from the encoding parameter used when the comparing target code stream is generated. Accordingly, the values of the encoding parameters may be different from each other.

For example, since the comparing target code stream and the specific image do not share the encoding parameter, the code block sizes may be different. The image comparison apparatus 100 obtains an inclusion relationship between the code blocks of the comparing target code stream and the specific image and determines the code block to be compared according to the inclusion relationship. Even in this case, the numbers of bit planes of the generated code streams between the comparing target code stream and the specific image can appropriately be compared with each other.

Since the number of zero bit planes of each code block only needs to be obtained, the image comparison apparatus 100 does not actually encode the specific image to the end. More specifically, according to the typical JPEG 2000 scheme, image data is subjected to wavelet transform, quantization, code block formation, bit plane development, and then entropy encoding. However, as described below, the image comparison apparatus 100 stops encoding the specific image before the entropy encoding.

As shown in FIG. 6, the image comparison apparatus 100 includes a wavelet transform unit 101, a quantization unit 102, a code block formation unit 103, a bit plane development unit 104, and a zero bit plane number detection unit 105.

The wavelet transform unit 101 performs wavelet transform on image data (indicated by an arrow 121) of an input specific image. The quantization unit 102 quantizes a wavelet coefficient (indicated by an arrow 122) generated by the wavelet transform unit 101.

The code block formation unit 103 forms a cod block of a quantized coefficient (indicated by an arrow 123) generated by the quantization unit 102 so as to have a predetermined code block size. The code block formation unit 103 notifies a code block size comparison unit 108 of the code block size. That is, the code block formation unit 103 sets the code block size to be use when the specific image is encoded according to the JPEG 2000 scheme.

The bit plane development unit 104 performs bit plane development on the code block (indicated by an arrow 124) generated by the code block formation unit 103.

The zero bit plane number detection unit 105 counts zero bit planes included in the bit planes (indicated by an arrow 126) developed by the bit plane development unit 104 and calculates the number of zero bit planes of each code block. That is, the zero bit plane number detection unit 105 detects the number of zero bit planes of each code block of the code stream obtained from the specific image encoded according to the JPEG 2000 scheme.

The image comparison apparatus 100 further includes a code stream analysis unit 106 and a zero bit plane number detection unit 107.

The code stream analysis unit 106 analyzes an input comparing target code stream (indicated by an arrow 131) to examine the code block size. That is, the code stream analysis unit 106 specifies the code block size of the comparing target code stream.

The zero bit plane number detection unit 107 detects the number of zero bit planes of each code block of the comparing target code stream (indicated by an arrow 132). According to the JPEG 2000 scheme, the coefficient data is encoded for each bit plane. Accordingly, the zero bit plane number detection unit 107 can specify the zero bit planes by analyzing the values of the respective bit planes of the comparing target code stream. The zero bit plane number detection unit 107 counts the zero bit planes. When the number of zero bit planes is described in a header or the like of the comparing target code stream, the zero bit plane number detection unit 107 may use information regarding the number of zero bit planes.

The image comparison apparatus 100 further includes a code block size comparison unit 108, a comparing target code block determination unit 109, and a zero bit plane number comparison unit 110.

The code block size comparison unit 108 compares the code block size (indicated by an arrow 125) obtained by forming the code block of the quantization coefficient of the specific image by the code block formation unit 103 with the code block size (indicated by an arrow 133) of the comparing target code stream examined by the code steam analysis unit 106, and then specifies the code bock inclusion relationship between the code bock sizes.

Based on the inclusion relationship (indicated by an arrow 141) of the code blocks specified by the code block size comparison unit 108, the comparing target code block determination unit 109 determines the comparing target code block which is a code block to be compared.

The zero bit plane number comparison unit 110 compares the number of zero bit planes (indicated by an arrow 127) of the specific image with the number of zero bit planes (indicated by an arrow 134) of the comparing target code stream for the comparing target code block according to the determination (indicated by an arrow 142). The code blocks for which the numbers of zero bit planes are compared with each other (comparing target code blocks) may be all of the code blocks of the specific image and the comparing target code stream or may be some of the code blocks.

The zero bit plane number comparison unit 110 determines whether the specific image is identical to the comparing target code stream depending on the comparison result, and then outputs the determination result (indicated by an arrow 143). The zero bit plane number comparison unit 110 determines that the specific image is identical to the comparing target code steam when the number of zero bit planes of the specific image is equal to the number of zero bit planes of the comparing target code stream for all the compared code blocks. On the contrary, the zero bit plane number comparison unit 110 determines that the specific image is not identical to the comparing target code stream, when there is at least one of the code blocks for which the numbers of zero bit planes are not equal to each other.

### [Code Block Inclusion Relationship]

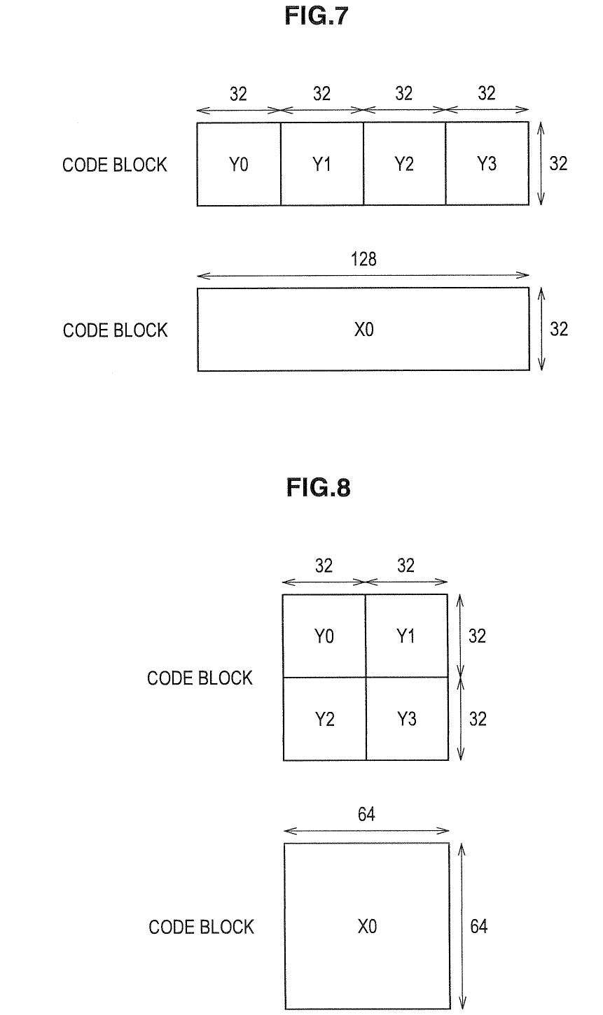

An example of a code block inclusion relationship will be described. For example, it is assumed that one code block size is 128×32 and another code block size is 32×32. In this case, the 128×32 code block includes four 32×32 code blocks at the same position. As shown in FIG. 7, Y0, Y1, Y2, and Y3 arranged in the horizontal direction correspond to one X0.

For example, it is assumed that one code block size is 64×64 and another code block size is 32×32. In this case, the number of 32×32 code blocks at the same position included in the 64×64 code block is four. As shown in FIG. 8, Y0, Y1, Y2, and Y3 arranged in the horizontal and vertical directions correspond to one X0.

The code block size comparison unit 108 examines the code block inclusion relationship by comparing the code block sizes.

The comparing target code block determination unit 109 determines a comparing target code block according to the code block inclusion relationship. In FIG. 7, for example, when X0 is determined as one comparing target code block, Y0 to Y3 corresponding to X0 are determined as the other comparing target code blocks.

### [Comparison Between Zero Bit Planes]

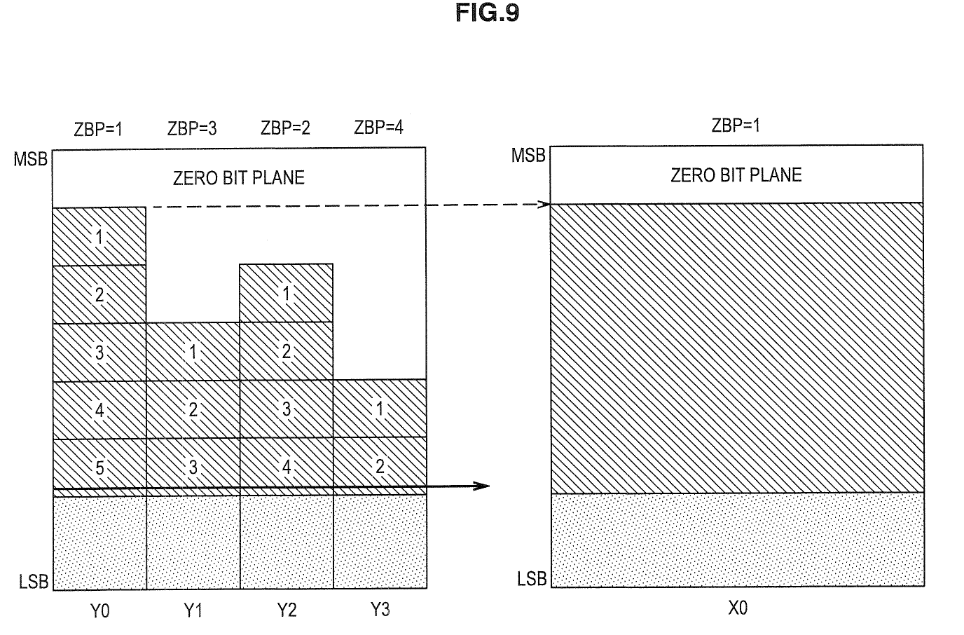

Next, an example in which the zero bit planes are compared when the code blocks are different in size will be described with reference to FIG. 9.

As shown in FIG. 9, the numbers of zero bit planes (ZBP) of the code blocks Y0 to Y3 are set to 1, 3, 2, and 4, respectively. The number of zero bit planes (ZBP) of the code block X0 is set to 1.

The bit plane with the most significant coefficient is not changed due to the nature of the development of the JPEG 2000 bit plane. Therefore, when the specific image and the comparing target code stream are different in code block size, the zero bit plane number comparison unit 110 may compare the number of zero bit planes of one code block with a relatively large code block size, with the small number of first zero bit planes out of a plurality of code blocks with a relatively small code block size.

### [Flow of Comparison Process]

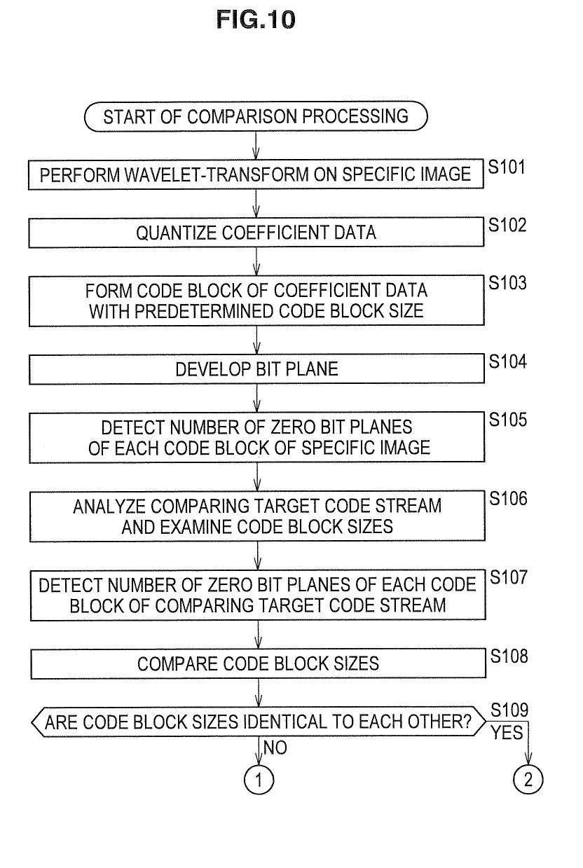

Next, an exemplary flow of the image comparison process described above will be described with reference to the flowcharts of FIGS. 10 to 12.

The comparison process starts when a specific image to be compared and a comparing target code stream are input into the image comparison apparatus 100. If the comparison process starts, the wavelet transform unit 101 performs wavelet transform on the specific image in step S101. In step S102, the quantization unit 102 quantizes coefficient data.

In step S103, the code block formation unit 103 forms the code block of the coefficient data so as to have the predetermined code block size. In step S104, the bit plane development unit 104 performs bit plane development on the coefficient data of each code block. In step S105, the zero bit plane number detection unit 105 detects the number of zero bit planes of the specific image.

In step S106, the code stream analysis unit 106 analyzes the comparing target code stream and examines the code block size. For example, the code block size is described in the header or the like of the code stream. In step S107, the zero bit plane number detection unit 107 detects the number of zero bit planes of each code block of the comparing target code stream.

In step S108, the code block size comparison unit 108 compares the code block size of the specific image used in the process of step S103 with the code block size of the comparing target code stream examined in step S106.

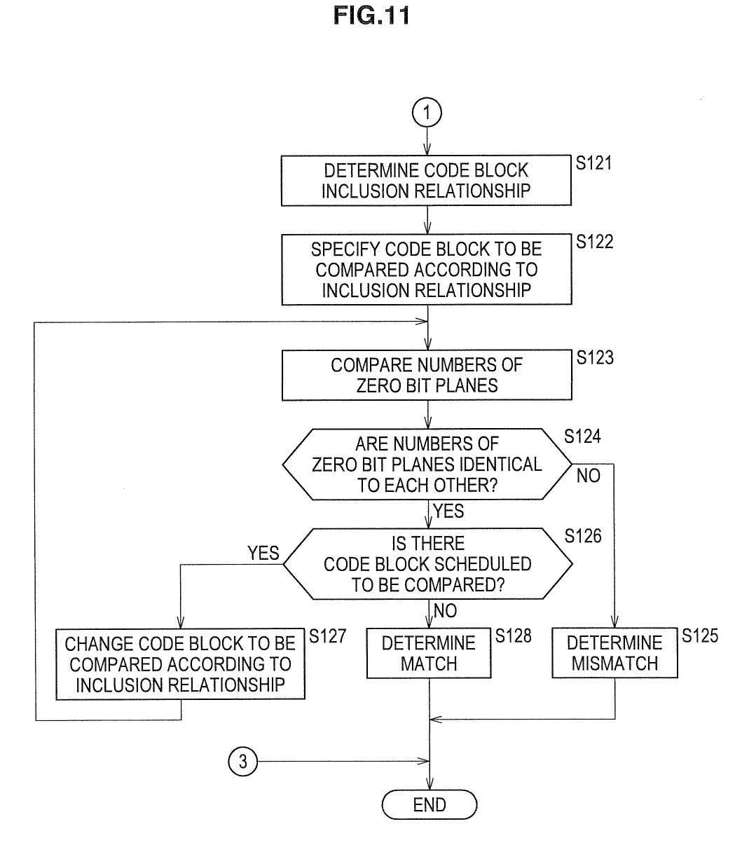

In step S109, the code block size comparison unit 108 determines whether the code block sizes are equal to each other. When the code block size comparison unit 108 determines that the code block sizes are not equal to each other, the process proceeds to step S121 of FIG. 11.

In step S121 of FIG. 11, the code block size comparison unit 108 determines the code block inclusion relationship between the specific image and the comparing target code stream. In step S122, the comparing target code block determination unit 109 specifies the comparing target code block which is a code block for which the number of zero bit planes is compared, according to the code block inclusion relationship determined in step S121.

In step S123, the zero bit plane number comparison unit 110 compares the numbers of zero bit planes of the comparing target code blocks with each other. In step S124, the zero bit plane number comparison unit 110 determines whether the numbers of zero bit planes of the comparing target code blocks are equal to each other between the specific image and the comparing target code stream. When the zero bit plane number comparison unit 110 determines that the numbers of zero bit planes are not equal to each other, the process proceeds to step S125 and the zero bit plane number comparison unit 110 determines that the specific image is not identical to the comparing target code stream. When the determination result of mismatch is output, the zero bit plane number comparison unit 110 terminates the comparison process.

On the other hand, when the zero bit plane number comparison unit 110 determines that the numbers of zero bit planes of the comparing target code blocks are equal to each other between the specific image and the comparing target code stream in step S124 of FIG. 11, the zero bit plane number comparison unit 110 allows the process to proceed to step S126. In step S126, the comparison target code block determination unit 109 determines whether there is still a code block scheduled to be compared.

When the comparison target code block determination unit 109 determines that there is a code block scheduled to be compared, the process proceeds to step S127 and the comparison target code block determination unit 109 changes the comparing target code block according to the code block inclusion relationship determined in step S121. If the comparison target code block determination unit 109 changes the comparing target code block, the process returns to step S123 to repeat the subsequent processes.

As described above, the comparing target code block determination unit 109 and the zero bit plane number comparison unit 110 repeat the processes of step S123 to step S127 to compare all of the code blocks scheduled to be compared. When there are the code blocks of which the numbers of zero bit planes are not equal, mismatch is determined in step S125 and the comparison process ends.

When mismatch is not determined and it is determined that there is no code block scheduled to be compared in step S126, the comparing target code block determination unit 109 allows the process to proceed to step S128. In step S128, the zero bit plane number comparison unit 110 determines that the specific image is identical to the comparing target code stream. When the determination result of match is output, the zero bit plane number comparison unit 110 terminates the comparison process.

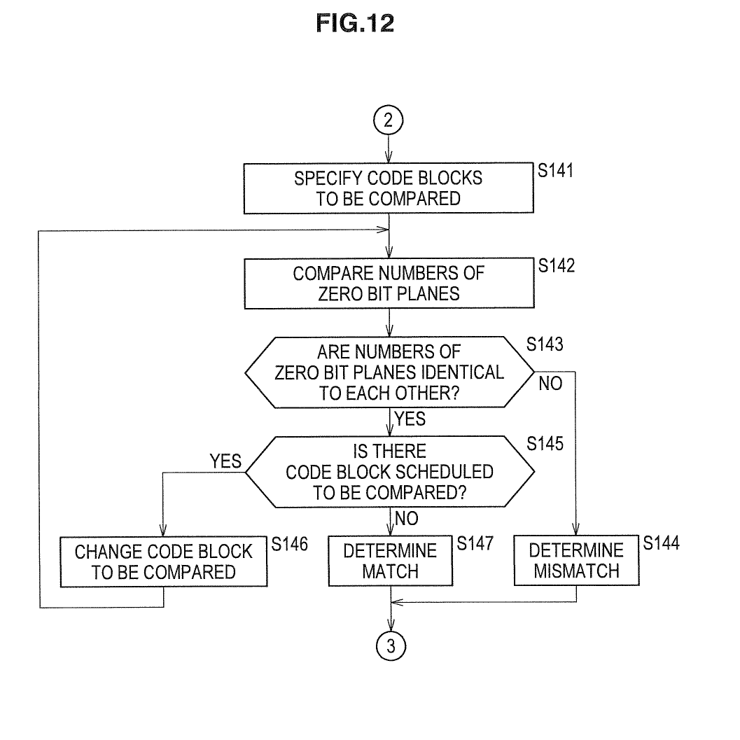

When the code block sizes are equal to each other in step S109 of FIG. 10, the code block size comparison unit 108 allows the process to proceed to step S141 of FIG. 12.

In this case, the numbers of zero bit planes are compared with each other, as in the related art.

That is, in step S141 of FIG. 12, the comparing target code block determination unit 109 specifies the comparing target code block which is a code block to be compared in number of zero bit planes.

In step S142, the zero bit plane number comparison unit 110 compares the numbers of zero bit planes of the comparing target code blocks. In step S143, the zero bit plane number comparison unit 110 determines whether the numbers of zero bit planes of the comparing target code blocks are equal to each other between the specific image and the comparing target code stream. When the zero bit plane number comparison unit 110 determines that the numbers of zero bit planes of the comparing target code blocks are not equal to each other, the process proceeds to step S144 and the zero bit plane number comparison unit 110 determines that the specific image is not identical to the comparing target code stream. When the determination result of mismatch is output, the zero bit plane number comparison unit 110 terminates the comparison process.

When the zero bit plane number comparison unit 110 determines that the numbers of zero bit planes of the comparing target code blocks are equal to each other in step S143 of FIG. 12 between the specific image and the comparing target code stream, the zero bit plane number comparison unit 110 allows the process to proceed to step S145. In step S145, the comparing target code block determination unit 109 determines whether there is still a code block scheduled to be compared.

When the comparing target code block determination unit 109 determines that there is a code block scheduled to be compared, the process proceeds to step S146 and the comparing target code block determination unit 109 changes the comparing target code block. The process returns to step S142 to repeat the subsequent processes when the comparing target code block determination unit 109 changes the comparing target code block.

As described above, the comparing target code block determination unit 109 and the zero bit plane number comparison unit 110 repeat the processes of step S142 to step S146 to compare all of the code blocks scheduled to be compared. When there is the code block for which the number of zero bit planes is not equal, mismatch is determined in the process of step S144 and the comparison process ends.

When mismatch is not determined and it is determined that there is no code block scheduled to be compared in step S145, the comparing target code block determination unit 109 allows the process to proceed to step S147. In step S147, the zero bit plane number comparison unit 110 determines that the specific image is identical to the comparing target code stream. When the determination result of match is output, the zero bit plane number comparison unit 110 terminates the comparison process.

Thus, by examining the code block inclusion relationship, determining the comparing target code block according to the code block inclusion relationship, and comparing the numbers of zero bit planes with each other, the image comparison apparatus 100 can classify images with more ease and high precision although the specific image and the comparing target code stream are different in code block size.

That is, when the image comparison apparatus 100 is applied to an image search system described with reference to FIG. 1, users can search for images with more ease and high precision.

The example has hitherto been described in which it is determined that the specific image is not identical to the comparing target code stream even when there is at least one code block for which the numbers of zero bit planes are different from each other. However, the mismatch between the images is determined according to an arbitrary criterion. For example, in order to improve a robust property and to prevent the determination from being erroneous due to a noise or the like, it may be determined that the specific image is not identical to the comparing target code stream, when the number of code blocks different in number of zero bit planes is equal to or greater than a predetermined threshold value.

For example, when there is at least one code block in which a difference in number of zero bit planes is equal to or greater than a predetermined value, it may be determined that the specific image is not identical to the comparing target code stream.

Thus, the image comparison apparatus can allow the difference in number of zero bit planes to some extent and can thus determine similarity between images although the images are not completely identical to each other.

Of course, a plurality of conditions may be combined. For example, it may be determined that the specific image is not identical to the comparing target code stream, when the number of code blocks, in which the difference in number of zero bit planes is equal to or greater than a predetermined threshold value, reaches a predetermined threshold value or more. For example, it may be determined that the specific image is not identical to the comparing target code stream, when there is at least one code block in which the difference in number of zero bit planes is equal to or greater than a predetermined value, or the number of code blocks different in number of zero bit planes reaches a predetermined threshold value or more.

### 2. Second Embodiment

### [Configuration of Image Comparison Apparatus]

In the above description, the image comparison apparatus 100 compares the specific image of baseband with the encoded comparing target code stream, but the invention is not limited thereto. For example, code streams may be compared with each other.

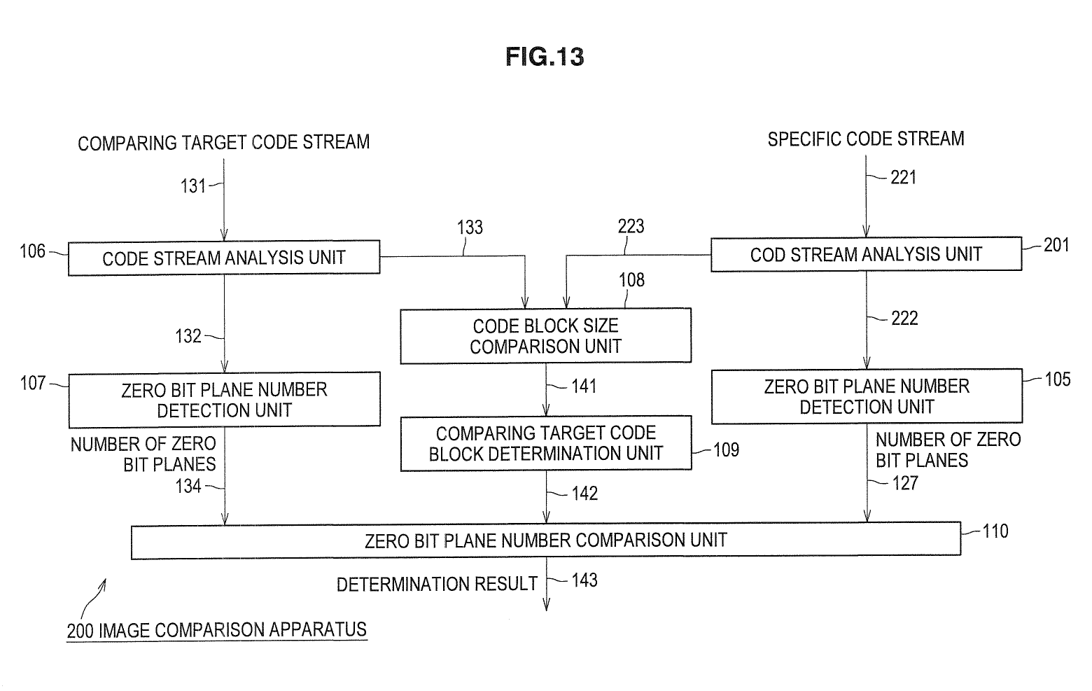

FIG. 13 is a block diagram illustrating an exemplary configuration of an image comparison apparatus according to an embodiment of the invention.

An image comparison apparatus 200 shown in FIG. 13 compares a specific code stream formed by encoding a specific image with a comparing target code stream to determine match or mismatch.

As shown in FIG. 13, the image comparison apparatus 200 basically has the same configuration as the image comparison apparatus 100 shown in FIG. 6. However, the image comparison apparatus 200 includes a code stream analysis unit 201 instead of the wavelet transform unit 101, the code block formation unit 103, and the like of the image comparison apparatus 100, since the specific code stream is input instead of the specific image.

As in the code stream analysis unit 106, the code stream analysis unit 201 analyzes the input specific code stream (indicated by an arrow 221) and examines the code block sizes. The zero bit plane number detection unit 105 detects the number of zero bit planes of each code block of the specific code stream (indicated by an arrow 222).

The code block size comparison unit 108 compares the code block size (indicated by an arrow 223) of the specific code stream examined by the code stream analysis unit 201 with the code block size (indicated by an arrow 133) of the comparing target code stream examined by the code stream analysis unit 106 to examine the code block inclusion relationship between the code bock sizes.

### [Flow of Comparison Process]

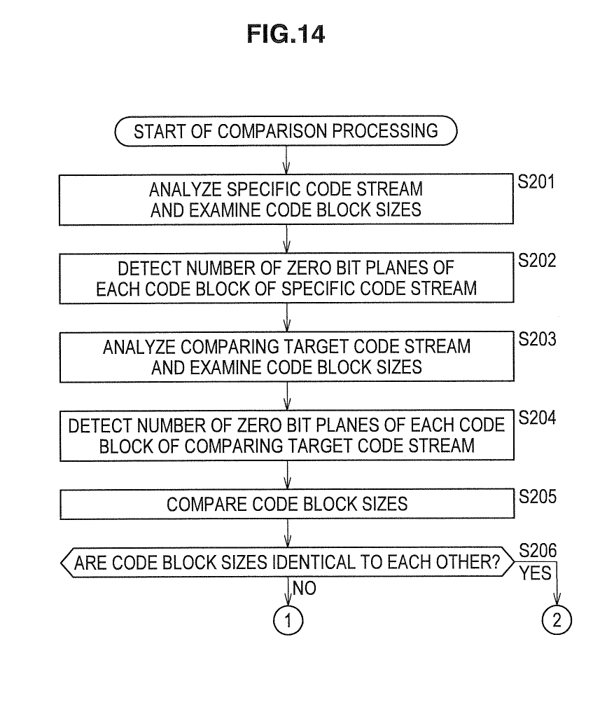

Next, an exemplary flow of a comparison process will be described with reference to the flowcharts of FIGS. 14 to 16. This comparison process is basically the same as the comparison process described with reference to FIGS. 10 to 12 according to the first embodiment.

However, the processes of step S201 and step S202 in FIG. 14 are performed instead of the process of step S101 to step S105 of FIG. 10.

In step S201, the code stream analysis unit 201 analyzes the specific code stream and examines the code block size. For example, the code block size is described in the header or the like of the code stream.

In step S202, the zero bit plane number detection unit 105 detects the number of zero bit planes of each code block of the specific code stream.

The processes of step S203 to step S206 of FIG. 14 are the same as the processes of step S106 to step S109 of FIG. 10, respectively. However, in step S205 of FIG. 14, the code block size comparison unit 108 compares the code block size of the specific code stream examined in step S201 with the code block size of the comparing target code stream examined in step S203.

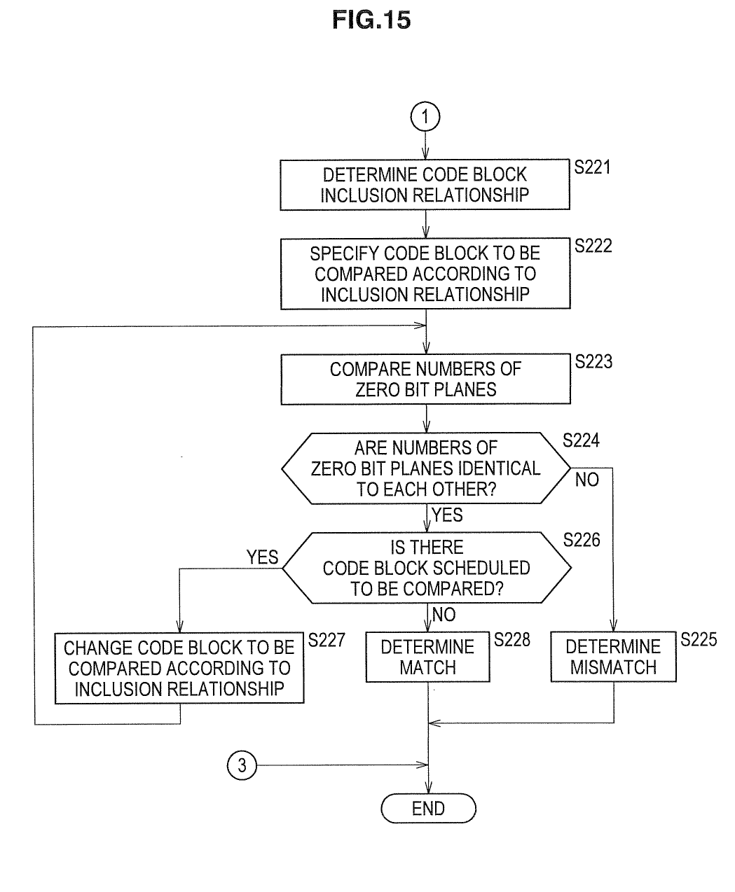

When the code block size of the specific code stream is not equal to that of the comparing target code stream in step S206, the code block size comparison unit 108 allows the process to proceed to step S221 of FIG. 15.

The processes of step S221 to step S228 of FIG. 15 are the same as those of step S121 to step S128 of FIG. 11, respectively.

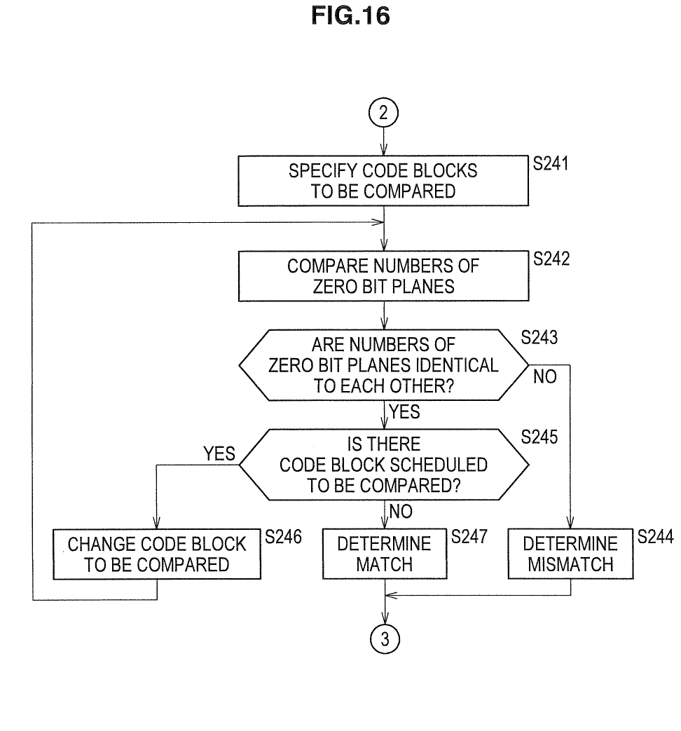

In step S206 of FIG. 14, when the code block size comparison unit 108 determines that the code block size of the specific code stream is equal to the code block size of the comparing target code stream, the process proceeds to step S241 of FIG. 16.

The processes of step S241 to step S247 of FIG. 16 are the same as those of step S141 to step S147 of FIG. 12, respectively.

That is, in this case, the numbers of zero bit planes are compared to each other, as in the related art.

As described above, the image comparison apparatus 200 examines the code block inclusion relationship between the specific code stream and the comparing target code stream, determines the comparing target code block according to the code block inclusion relationship, and compares the number of zero bit planes. Accordingly, the image comparison apparatus 200 can classify images with more ease and high precision even when the specific code stream and the comparing target code stream are different in code block size.

That is, the image comparison apparatus 200 compares the code streams encoded according to the JPEG 2000 scheme and determines the match or mismatch of the both images. Moreover, when the image comparison apparatus 200 is applied to an image search system described with reference to FIG. 1, users can search for images with more ease and high precision.

In the image comparison apparatus 200, the mismatch between the images is determined according to an arbitrary criterion, as in the image comparison apparatus 100.

### 3. Third Embodiment

### [Configuration of Image Comparison Apparatus]

As described above, the images in which the code block sizes of the encoding parameter are different from each other are compared with each other. However, even when an encoding parameter other than the code block size is changed, images can be compared more easily and rapidly, as in the above-described case.

For example, images may be compared with each other for the code streams different in number of resolution levels (the number of division levels) of the wavelet transform.

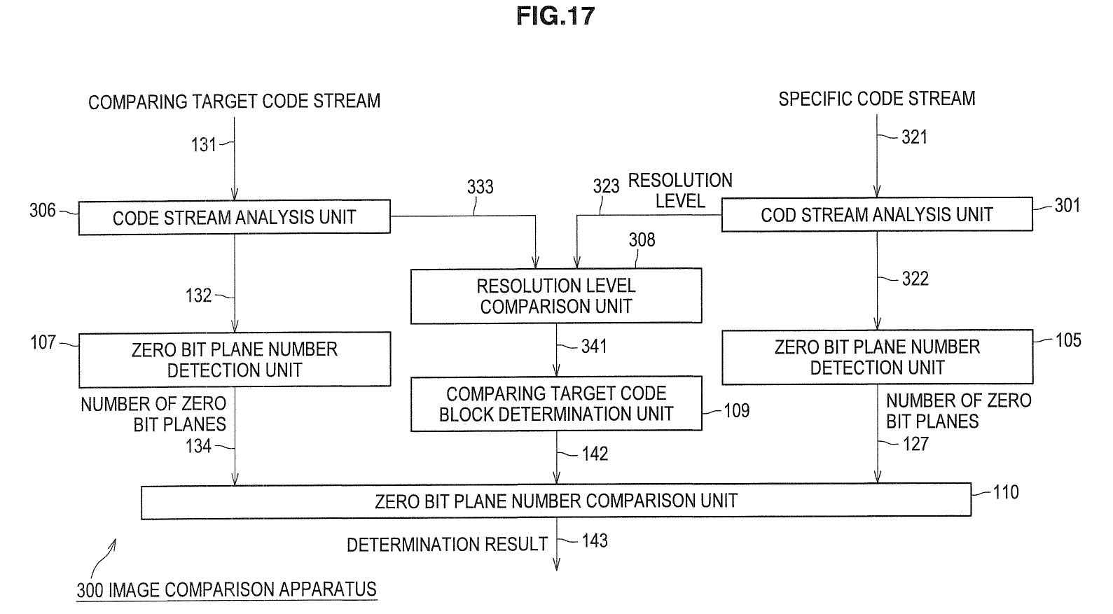

FIG. 17 is a block diagram illustrating still another exemplary configuration of an image comparison apparatus according to an embodiment of the invention.

An image comparison apparatus 300 shown in FIG. 17 compares a specific code stream subjected to wavelet transform with a comparing target code stream, which are different in number of resolution levels, to determine match or mismatch. Hereinafter, it is assumed that the specific code stream and the comparing target code stream are equal to each other in code block size.

As shown in FIG. 17, the image comparison apparatus 300 basically has the same configuration as the image comparison apparatus 200 shown in FIG. 13. However, the image comparison apparatus 300 includes a code stream analysis unit 301 instead of the code stream analysis unit 201 of the image comparison apparatus 200.

The code stream analysis unit 301 analyzes an input specific code stream (indicated by an arrow 321) and examines the resolution levels. The zero bit plane number detection unit 105 detects the number of zero bit planes of each code block of the specific code stream (indicated by an arrow 322).

The image comparison apparatus 300 includes a code stream analysis unit 306 instead of the code stream analysis unit 106 of the image comparison apparatus 200.

The code stream analysis unit 306 analyzes an input comparing target code stream (indicated by an arrow 131) and examines the resolution level. The zero bit plane number detection unit 107 detects the number of zero bit planes of each code block of the comparing target code stream (indicated by an arrow 132).

The image comparison apparatus 300 includes a resolution level comparison unit 308 instead of the code block size comparison unit 108 of the image comparison apparatus 200. The resolution level comparison unit 308 compares a resolution level (indicated by an arrow 323) of the specific code stream examined by the code stream analysis unit 301 with a resolution level (indicated by an arrow 333) of the comparing target code stream examined by the code stream analysis unit 306 and examines a common sub band.

The comparing target code block determination unit 109 determines comparing target code blocks that are to be compared in number of zero bit planes for the resolution level (sub-band) (indicated by an arrow 341) detected by the resolution level comparison unit 308 and common to the specific code stream and the comparing target code stream.

According to the determination (indicated by an arrow 142), the zero bit plane number comparison unit 110 compares the number of zero bit planes (indicated by an arrow 127) of the specific code stream with the number of zero bit planes (indicated by an arrow 134) of the comparing target code stream for the comparing target code block.

The zero bit plane number comparison unit 110 determines whether the specific code stream is identical to the comparing target code stream according to the comparison result and outputs the determination result (indicated by an arrow 143).

### [Resolution Level]

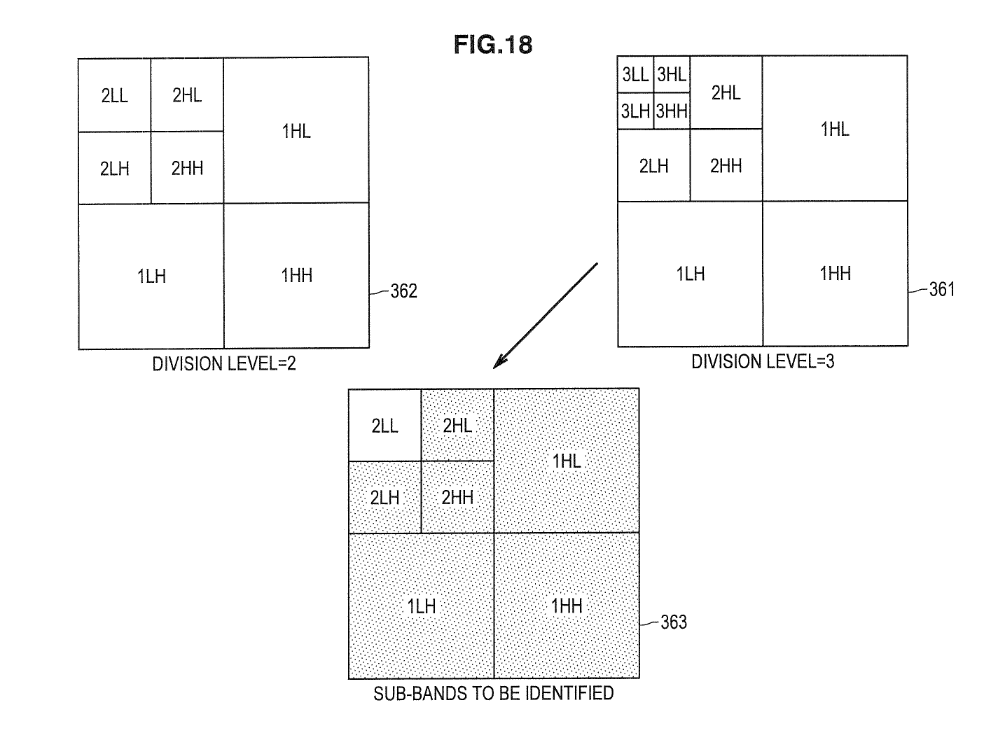

FIG. 18 is a diagram illustrating an example of classification when the numbers of resolution levels are different.

For example, when the number of division levels of a specific code stream 361 is 3 and the number of division levels of a comparing target code stream 362 is 3, as shown in FIG. 18, sub-bands 2LH, 2HL, 2HH, 1LH, 1HL, and 1HH are common to the specific code stream 361 and the comparing target code stream 362. The comparing target code block determination unit 109 sets code blocks included in a sub-band group 363 as comparing targets.

In other words, the comparing target code block determination unit 109 does not set the code blocks of sub-bands 2LL, 1HH, 1HL, 1LH, and 1LL, which are not common to the specific code stream and the comparing target code stream, as the comparing targets.

### [Flow of Comparison Process]

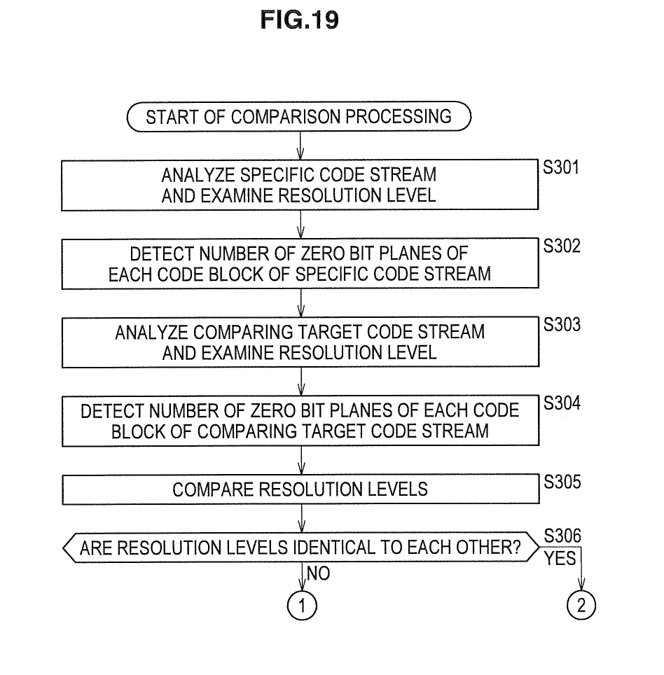

Next, an exemplary flow of a comparison process in this case will be described with reference to the flowcharts of FIGS. 19 to 21. This comparison process is basically the same as the comparison process described with reference to FIGS. 14 to 16 according to the second embodiment.

In step S301 of FIG. 19, the code stream analysis unit 301 analyzes the specific code stream and examines the resolution level. The resolution level is described in the header or the like of the code stream.

In step S302, the zero bit plane number detection unit 105 detects the number of zero bit planes of each code block of the specific code stream, as in step S202 of FIG. 14.

In step S303, the code stream analysis unit 306 analyzes the comparing target code stream and examines the resolution level. The resolution level is described in the header or the like of the code stream.

In step S304, the zero bit plane number detection unit 107 detects the number of zero bit planes of each code block of the comparing target code stream, as in step S204 of FIG. 14.

In step S305, the resolution level comparison unit 308 compares the resolution level of the specific code stream examined in step S301 with the resolution level of the comparing target code stream examined in step S303.

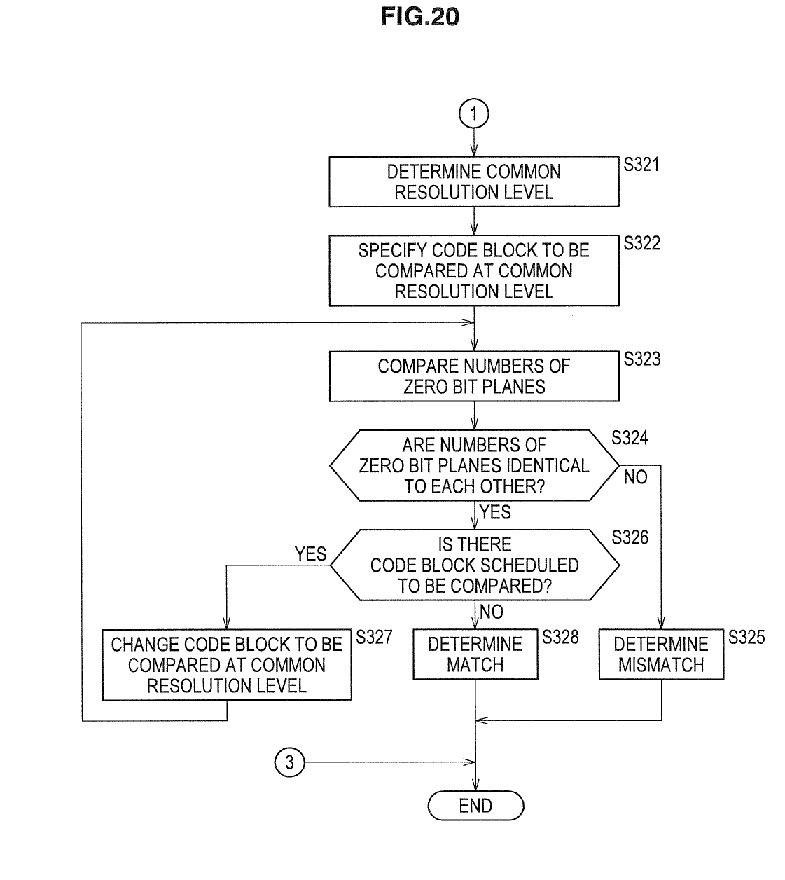

In step S306, the resolution level comparison unit 308 determines whether the resolution levels are identical to each other. When the resolution level comparison unit 308 determines that the resolution levels are not identical to each other, the process proceeds to step S321 of FIG. 20.

In step S321 of FIG. 20, the resolution level comparison unit 308 determines a resolution level (sub-band) which is common to the specific code stream and the comparing target code stream. In step S322, the comparing target code block determination unit 109 specifies the comparing target code block which is a code block to be compared in number of zero bit planes for the common resolution level (sub-band) determined in step S321.

The processes of step S323 to step S328 of FIG. 20 are the same as those of step S223 to step S228 of FIG. 15, respectively.

However, in step S327, the comparing target code block determination unit 109 changes the comparing target code block for the common resolution level determined step S321.

When mismatch is determined in step S325 or match is determined in step S328, the comparison process ends.

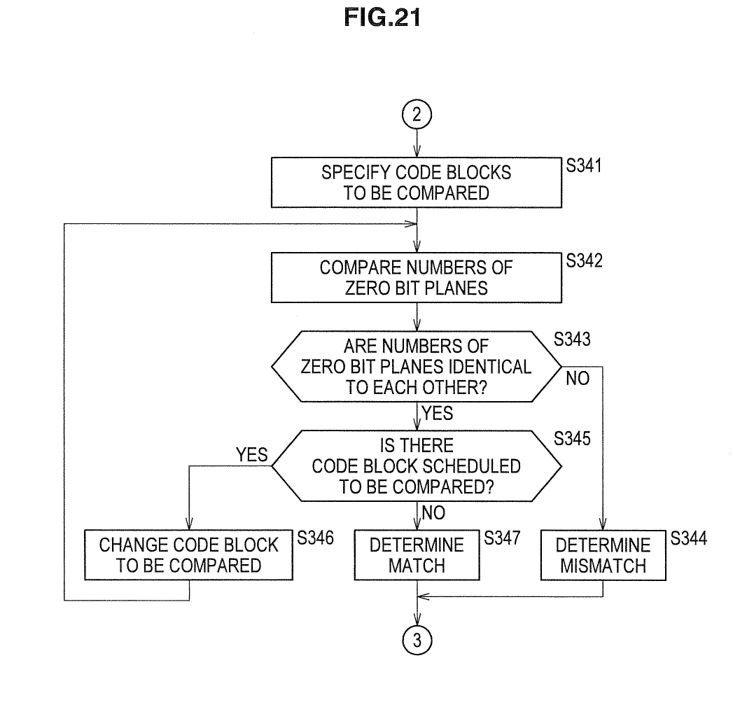

When it is determined that the resolution level of the specific code stream is identical to the resolution level of the comparing target code stream in step S306 of FIG. 19, the resolution level comparison unit 308 allows the process to proceed to step S341 of FIG. 21.

The processes of step S341 to step S347 of FIG. 21 are the same as those of step S241 to step S247 of FIG. 16, respectively.

That is, in this case, the numbers of zero bit planes are compared to each other, as in the related art.

Even when the specific code stream and the comparing target code stream are different in number of division levels (resolution levels) of the wavelet transform, as described above, the image comparison apparatus 300 detects the common resolution level and compares the numbers of zero bit planes with each other in the common resolution level. Thus, even when the specific code stream and the comparing target code stream are different in resolution level, the image comparison apparatus 300 can classify images with more ease and high precision.

That is, the image comparison apparatus 300 can compare the code streams encoded according to the JPEG 2000 scheme and having different resolution levels and can determine whether both images are identical to each other. Moreover, when the image comparison apparatus 300 is applied to the image search system described with reference to FIG. 1, users can search for images with more ease and high precision.

As in the image comparison apparatus 100, the mismatch between the images is determined according to an arbitrary criterion in the image comparison apparatus 300.

As in the first embodiment, a specific image of the baseband may be input instead of the specific code stream. In this case, as in the first embodiment, the specific image is subjected to wavelet transform, quantization, code block formation, and bit plane development, and then the numbers of zero bit planes are compared with each other.

The specific code stream (specific image) and the comparing target code stream may be different in the code block size. In this case, as described in the third embodiment, the image comparison apparatus determines the common resolution level (sub-band), obtains the inclusion relationship for the code block of the common resolution level to determine the comparing target code block according to the inclusion relationship, as described in the first and second embodiments.

Thus, even when the plurality of encoding parameters is different, the image comparison apparatus can classify images easily and rapidly. As described above, the code block size and the resolution level have been described as examples of the encoding parameters. However, other encoding parameters may be set to be different.

### 4. Fourth Embodiment

### [Personal Computer]

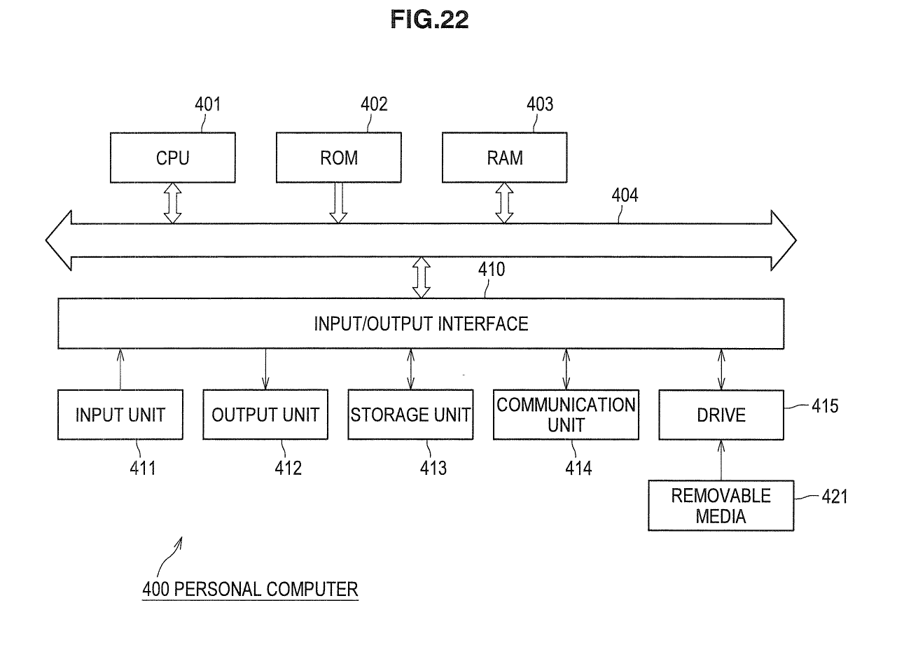

The above-described series of processes may be executed by hardware or software. In this case, for example, a personal computer shown in FIG. 22 may be configured.

In FIG. 22, a CPU 401 of a personal computer 400 executes a program stored in a ROM (Read Only Memory) 402 or various kinds of processes according to a program loaded from a storage unit 413 to a RAM (Random Access Memory) 403. The RAM 403 appropriately stores data or the like necessary for the CPU 401 to execute various kinds of processes.

The CPU 401, the ROM 402, and the RAM 403 are connected to each other via a bus 404. An input/output interface 410 is also connected to the bus 404.

An input unit 411 formed by a keyboard, a mouse, and the like, a display formed by a cathode ray tube (CRT), a liquid crystal display (LCD), or the like, an output unit 412 formed by a loudspeaker or the like, a storage unit 413 formed by a hard disk or the like, and a communication unit 414 formed by a modem or the like are connected to the input/output interface 410. The communication unit 414 performs communication through a network including the Internet.

A drive 415 is connected to the input/output interface 410, as necessary, and a removable medium 421 such as a magnetic disc, an optical disc, a magneto-optical disc, or a semiconductor memory is appropriately mounted, so that a computer program that is read therefrom is installed into the storage unit 413, as necessary.

When the above-described series of processes are executed by software, a program implementing the software is installed from a network or a recording medium.

For example, as shown in FIG. 22, the recording medium includes, independently from the apparatus main body, the removable medium 421, which is distributed to users to deliver a program and stores a program, and is formed by a magnetic disc (including a flexible disc), an optical disc (including a compact disc-read only memory (CD-ROM) and a digital versatile disc (DVD)), a magneto-optical disc (including a mini disc (MD)), a semiconductor memory, or the like. Moreover, the recording medium includes the ROM 402 storing a program and embedded in advance to the apparatus main body so as to be delivered to users and a hard disc included in the storage unit 413.

A program executed by a computer may be a program executing the processes in time series in the sequence described in the specification, in parallel, or at timing necessary when called.

In the specification, steps of describing the program stored in the recording medium may include processes executed in time series in the described sequence. Of course, the steps may include processes executed in parallel or individually, not in time series.

In the specification, the system indicates the entire apparatus including a plurality of devices (apparatuses).

The configuration described above as one apparatus (or processing unit) may be separated into a plurality of apparatuses (or processing units). On the contrary, the configurations described above as a plurality of apparatuses (or processing units) may be integrated into one apparatus (or processing unit). Configurations other than the above-described configuration may be added to the configuration of each apparatus (or processing unit). Moreover, when the configuration or operation of the entire system is substantially the same, a part of the configuration of an apparatus (or processing unit) may be included in the configuration of another apparatus (or another processing unit). That is, the embodiments of the invention are not limited to the above-described embodiments, but may be modified in various forms without departing from the scope of the invention.

The embodiments of the invention are applicable to an arbitrary apparatus or system including a digital cinema editing apparatus, an archive system, a broadcast image delivering apparatus, an image database, a medical image recording system, a network server, an image transmission apparatus on the Internet, a wireless transmission apparatus, a secondary video delivery apparatus from a theater, a non-linear editing apparatus, a game console, a television receiver system, an HDD recorder, an authoring tool on a PC or a software module thereof, and the like.

The present application contains subject matter related to that disclosed in Japanese Priority Patent Application JP 2010-089326 filed in the Japan Patent Office on Apr. 8, 2010, the entire content of which is hereby incorporated by reference.

What is claimed is:

1. An image comparison apparatus which compares a specific image with a first code stream obtained by encoding an image according to a JPEG 2000 scheme and determines whether the image before the encoding of the first code stream is identical to the specific image, the image comparison apparatus comprising:
encoding parameter specifying means for analyzing the first code stream and specifying an encoding parameter used when the first code stream is generated;
first zero bit plane number detection means for detecting the number of zero bit planes of each code block of the first code stream;
encoding parameter setting means for encoding the specific image according to the JPEG 2000 scheme and setting an encoding parameter to be used when a second code stream is generated;
second zero bit plane number detection means for detecting the number of zero bit planes of each code block of the second code stream obtained by encoding the specific image according to the JPEG 2000 scheme;
encoding parameter comparison means for comparing the encoding parameter specified by the encoding parameter specifying means with the encoding parameter set by the encoding parameter setting means; and
determination means for comparing the number of zero bit planes detected by the first zero bit plane number detection means with the number of zero bit planes detected by the second zero bit plane number detection means between the code blocks corresponding to each other in the first and second code streams according to a relationship between the encoding parameters compared and specified by the encoding parameter comparison means, determining that the image before the encoding of the first code stream is identical to the specific image when the numbers of zero bit planes are equal to each other, and determining that the image before the encoding of the first code stream is not identical to the specific image when the numbers of zero bit planes are not equal to each other.

2. The image comparison apparatus according to claim 1,
wherein the encoding parameter includes a code block size,
the encoding parameter specifying means specifies a code block size of the first code stream,
the encoding parameter setting means sets a code block size of the second code stream,
the encoding parameter comparison means compares the code block size of the first code stream with the code block size of the second code stream to specify an inclusion relationship between the code block of the first code stream and the code block of the second code stream, and
the determination means compares the numbers of zero bit planes with each other between the code blocks corresponding to each other in the first and second code streams according to the inclusion relationship.

3. The image comparison apparatus according to claim 1,
wherein the encoding parameter includes the number of division levels of wavelet transform,
the encoding parameter specifying means specifies the number of division levels of the first code stream,
the encoding parameter setting means sets the number of division levels of the second code stream,
the encoding parameter comparison means compares the number of division levels of the first code stream with the number of division levels of the second code stream to specify a sub-band which is common to the first and second code streams, and
the determination means compares the numbers of zero bit planes with each other between the code blocks corresponding to each other in the sub-band which is common to the first and second code streams.

4. The image comparison apparatus according to claim 1,
wherein the determination means determines that the image before the encoding of the first code stream is not identical to the specific image, when the number of code blocks determined not to be equal in the number of zero bit planes is equal to or greater than a predetermined threshold value.

5. The image comparison apparatus according to claim 1,
wherein the determination means determines that the image before the encoding of the first code stream is not identical to the specific image, when there is a code block in which a difference in the number of zero bit planes is equal to or greater than a predetermined threshold value.

6. An image comparison method of an image comparison apparatus which compares a specific image with a first code stream obtained by encoding an image according to a JPEG 2000 scheme and determines whether the image before the encoding of the first code stream is identical to the specific image, the image comparison method comprising the steps of:
analyzing the first code stream and specifying an encoding parameter used when the first code stream is generated, by encoding parameter specifying means of the image comparison apparatus;
detecting the number of zero bit planes of each code block of the first code stream, by first zero bit plane number detection means of the image comparison apparatus;
encoding the specific image according to the JPEG 2000 scheme and setting an encoding parameter to be used when a second code stream is generated, by encoding parameter setting means of the image comparison apparatus;
detecting the number of zero bit planes of each code block of the second code stream obtained by encoding the specific image according to the JPEG 2000 scheme, by second zero bit plane number detection means of the image comparison apparatus;
comparing the specified encoding parameter with the set encoding parameter, by encoding parameter comparison means of the image comparison apparatus; and
comparing the numbers of zero bit planes detected in the code blocks corresponding to each other in the first and second code streams according to a relationship between the compared and specified encoding parameters, determining that the image before the encoding of the first code stream is identical to the specific image when the numbers of zero bit planes are equal to each other, and determining that the image before the encoding of the first code stream is not identical to the specific image when the numbers of zero bit planes are not equal to each other, by determination means of the image comparison apparatus.

7. A program causing a computer, which compares a specific image with a first code stream obtained by encoding an image according to a JPEG 2000 scheme and determines whether the image before the encoding of the first code stream is identical to the specific image, to function as:
encoding parameter specifying means for analyzing the first code stream and specifying an encoding parameter used when the first code stream is generated;
first zero bit plane number detection means for detecting the number of zero bit planes of each code block of the first code stream;
encoding parameter setting means for encoding the specific image according to the JPEG 2000 scheme and setting an encoding parameter to be used when a second code stream is generated;
second zero bit plane number detection means for detecting the number of zero bit planes of each code block of the second code stream obtained by encoding the specific image according to the JPEG 2000 scheme;
encoding parameter comparison means for comparing the encoding parameter specified by the encoding parameter specifying means with the encoding parameter set by the encoding parameter setting means; and
determination means for comparing the number of zero bit planes detected by the first zero bit plane number detection means with the number of zero bit planes detected by the second zero bit plane number detection means between the code blocks corresponding to each other in the first and second code streams according to a relationship between the encoding parameters compared and specified by the encoding parameter comparison means, determining that the image before the encoding of the first code stream is identical to the specific image when the numbers of zero bit planes are equal to each other, and determining that the image before the encoding of the first code stream is not identical to the specific image when the numbers of zero bit planes are not equal to each other.

8. An image comparison apparatus which compares first and second code streams with each other, which are obtained by encoding images according to a JPEG 2000 scheme, and determines whether the images before the encoding of the first and second code streams are identical to each other, the image comparison apparatus comprising:
first encoding parameter specifying means for analyzing the first code stream and specifying an encoding parameter used when the first code stream is generated;
first zero bit plane number detection means for detecting the number of zero bit planes of each code block of the first code stream;
second encoding parameter specifying means for analyzing the second code stream and specifying an encoding parameter used when the second code stream is generated;
second zero bit plane number detection means for detecting the number of zero bit planes of each code block of the second code stream;
encoding parameter comparison means for comparing the encoding parameter specified by the first encoding parameter specifying means with the encoding parameter specified by the second encoding parameter specifying means; and
determination means for comparing the number of zero bit planes detected by the first zero bit plane number detection means with the number of zero bit planes detected by the second zero bit plane number detection means between the code blocks corresponding to each other in the first and second code streams according to a relationship between the encoding parameters compared and specified by the encoding parameter comparison means, determining the images before the encoding of the first and second code streams are identical to each other when the numbers of zero bit planes are equal to each other, and determining that the images before the encoding of the first and second code streams are not identical to each other when the numbers of zero bit planes are not equal to each other.

9. The image comparison apparatus according to claim 8,
wherein the encoding parameter includes a code block size,
the first encoding parameter specifying means specifies a code block size of the first code stream,
the second encoding parameter specifying means specifies a code block size of the second code stream,
the encoding parameter comparison means compares the code block size of the first code stream with the code block size of the second code stream to specify an inclusion relationship between the code block of the first code stream and the code block of the second code stream, and
the determination means compares the numbers of zero bit planes with each other between the code blocks corresponding to each other in the first and second code streams according to the inclusion relationship.

10. The image comparison apparatus according to claim 8,
wherein the encoding parameter includes the number of division levels of wavelet transform,
the first encoding parameter specifying means specifies the number of division levels of the first code stream,
the second encoding parameter specifying means specifies the number of division levels of the second code stream,
the encoding parameter comparison means compares the number of division levels of the first code stream with the number of division levels of the second code stream to specify a sub-band which is common to the first and second code streams, and
the determination means compares the numbers of zero bit planes to each other between the code blocks corresponding to each other in the sub-band which is common to the first and second code streams.

11. The image comparison apparatus according to claim 8,
wherein the determination means determines that the images before the encoding of the first and second code streams are not identical to each other, when the number of code blocks determined not to be equal in the number of zero bit planes is equal to or greater than a predetermined threshold value.

12. The image comparison apparatus according to claim 8,
wherein the determination means determines that the images before the encoding of the first and second code streams are not identical to each other, when there is a code block in which a difference in the number of zero bit planes is equal to or greater than a predetermined threshold value.

13. An image comparison method of an image comparison apparatus which compares first and second code streams with each other, which are obtained by encoding images according to a JPEG 2000 scheme, and determines whether the images before the encoding of the first and second code streams are identical to each other, the image comparison method comprising the steps of:
analyzing the first code stream and specifying an encoding parameter used when the first code stream is generated, by first encoding parameter specifying means of the image comparison apparatus;
detecting the number of zero bit planes of each code block of the first code stream, by first zero bit plane number detection means of the image comparison apparatus;
analyzing the second code stream and specifying an encoding parameter used when the second code stream is generated, by second encoding parameter specifying means of the image comparison apparatus;
detecting the number of zero bit planes of each code block of the second code stream, by second zero bit plane number detection means of the image comparison apparatus;
comparing the encoding parameter specified by the first encoding parameter specifying means with the encoding parameter specified by the second encoding parameter specifying means, by encoding parameter comparison means of the image comparison apparatus; and
comparing the numbers of zero bit planes between the code blocks corresponding to each other in the first and second code streams according to a relationship between the compared and specified encoding parameters, determining that the images before the encoding of the first and second code streams are identical to each other when the numbers of zero bit planes are equal to each other, and determining that the images before the encoding of the first and second code streams are not identical to each other when the numbers of zero bit planes are not equal to each other, by determination means of the image comparison apparatus.

14. A program causing a computer, which compares first and second code streams with each other, which are obtained by encoding images according to a JPEG 2000 scheme, and determines whether the images before the encoding of the first and second code streams are identical to each other, to function as:
first encoding parameter specifying means for analyzing the first code stream and specifying an encoding parameter used when the first code stream is generated;
first zero bit plane number detection means for detecting the number of zero bit planes of each code block of the first code stream;
second encoding parameter specifying means for analyzing the second code stream and specifying an encoding parameter used when the second code stream is generated;
second zero bit plane number detection means for detecting the number of zero bit planes of each code block of the second code stream;
encoding parameter comparison means for comparing the encoding parameter specified by the first encoding parameter specifying means with the encoding parameter specified by the second encoding parameter specifying means; and
determination means for comparing the number of zero bit planes detected by the first zero bit plane number detection means with the number of zero bit planes detected by the second zero bit plane number detection means between the code blocks corresponding to each other in the first and second code streams according to a relationship between the encoding parameters compared and specified by the encoding parameter comparison means, determining that the images before the encoding of the first and second code streams are identical to each other when the numbers of zero bit planes are equal to each other, and determining that the images before the encoding of the first and second code streams are not identical to each other when the numbers of zero bit planes are not equal to each other.

15. An image comparison apparatus which compares a specific image with a first code stream obtained by encoding an image according to a JPEG 2000 scheme and determines whether the image before the encoding of the first code stream is identical to the specific image, the image comparison apparatus comprising:
an encoding parameter specifying unit analyzing the first code stream and specifying an encoding parameter used when the first code stream is generated;
a first zero bit plane number detection unit detecting the number of zero bit planes of each code block of the first code stream;
an encoding parameter setting unit encoding the specific image according to the JPEG 2000 scheme and setting an encoding parameter to be used when a second code stream is generated;
a second zero bit plane number detection unit detecting the number of zero bit planes of each code block of the second code stream obtained by encoding the specific image according to the JPEG 2000 scheme;
an encoding parameter comparison unit comparing the encoding parameter specified by the encoding parameter specifying unit with the encoding parameter set by the encoding parameter setting unit; and
a determination unit comparing the number of zero bit planes detected by the first zero bit plane number detection unit with the number of zero bit planes detected by the second zero bit plane number detection unit between the code blocks corresponding to each other in the first and second code streams according to a relationship between the encoding parameters compared and specified by the encoding parameter comparison unit, determining that the image before the encoding of the first code stream is identical to the specific image when the numbers of zero bit planes are equal to each other, and determining that the image before the encoding of the first code stream is not identical to the specific image when the numbers of zero bit planes are not equal to each other.

16. An image comparison apparatus which compares first and second code streams with each other, which are obtained by encoding images according to a JPEG 2000 scheme, and determines whether the images before the encoding of the first and second code streams are identical to each other, the image comparison apparatus comprising:
a first encoding parameter specifying unit analyzing the first code stream and specifying an encoding parameter used when the first code stream is generated;
a first zero bit plane number detection unit detecting the number of zero bit planes of each code block of the first code stream;
a second encoding parameter specifying unit analyzing the second code stream and specifying an encoding parameter used when the second code stream is generated;
a second zero bit plane number detection unit detecting the number of zero bit planes of each code block of the second code stream;
an encoding parameter comparison unit comparing the encoding parameter specified by the first encoding parameter specifying unit to the encoding parameter specified by the second encoding parameter specifying unit; and
a determination unit comparing the number of zero bit planes detected by the first zero bit plane number detection unit with the number of zero bit planes detected by the second zero bit plane number detection unit between the code blocks corresponding to each other in the first and second code streams according to a relationship between the encoding parameters compared and specified by the encoding parameter comparison unit, determining the images before the encoding of the first and second code streams are identical to each other when the numbers of zero bit planes are equal to each other, and determining that the images before the encoding of the first and second code stream are not identical to each other when the numbers of zero bit planes are not equal to each other.
